(19) United States
(12) Patent Application Publication
(10) Pub. No.: US 2013/0162904 A1
(43) Pub. Date: Jun. 27, 2013

(54) SIGNAL PROCESSING DEVICE, SIGNAL PROCESSING METHOD, PROGRAM, RECORDING MEDIUM, AND SIGNAL PROCESSING SYSTEM

(71) Applicant: Sony Corporation, Tokyo (JP)

(72) Inventors: Chisato KEMMOCHI, Kanagawa (JP); Kyosuke MATSUMOTO, Tokyo (JP); Shusuke TAKAHASHI, Chiba (JP)

(73) Assignee: SONY CORPORATION, Tokyo (JP)

(21) Appl. No.: 13/719,617

(22) Filed: Dec. 19, 2012

(30) Foreign Application Priority Data
Dec. 26, 2011 (JP) 2011283816

(51) Int. Cl. H04N 5/04

(52) U.S. Cl. CPC H04N 5/04
USPC 348/515

(57) ABSTRACT

A signal processing device includes: a feature amount calculation unit calculating the respective feature amount of a first audio signal obtained through a first communication pathway and a second audio signal obtained through a second communication pathway corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

### BACKGROUND

The present technology relates to a signal processing device, a signal processing method, a program, a recording medium, and a signal processing system, and particularly relates to a signal processing device, a signal processing method, a program, a recording medium, and a signal processing system in which a sub audio signal that is the same or similar to a main audio signal by being synchronized with the main audio signal is able to be output.

In the related art, improvements in the sound quality of output audio or the like in audio signal processing devices according to the needs of the user have been realized.

For example, manufacturers of television sets as audio signal processing devices have realized improvements in the sound quality of output audio by designing television sets so that sounds spread out, improving the performance of speakers that television sets include, separately vending high-performance speakers, and the like. Further, there are also cases where improvements in the sound quality of output audio are realized by the user preparing an audio amplifier, speakers, and the like separately from the television set.

While improvements in sound quality through hardware have been realized in such a manner, improvements in sound quality through software have also been realized. Improvements in the sound quality of output audio have been realized through digital signal processing such as, for example, widening the frequency band (for example, refer to Japanese Unexamined Patent Application Publication No. 2008-139844), adding the spread of sounds, adjusting to a more easily audible sound quality, and the like.

Further, since television broadcasts and the like use usable radio waves by sharing frequency bands, transmission bands are limited, and audio signals are transmitted using a predetermined compression encoding method.

For example, in terrestrial digital broadcasting in Japan, an MPEG2 (Moving Picture Experts Group phase 2) AAC (Advanced Audio Coding) method has been adopted as a compression encoding method. The encoding of such a compression encoding method is irreversible encoding in which the audio signals before and after encoding do not match, and it is recognized that the sound quality deteriorates through the encoding process. Due to the deterioration in sound quality, in 1 segment terrestrial digital broadcasting for mobile phones and mobile terminals known as 1-seg broadcasting, particularly received by a mobile apparatus or the like, the audio may be difficult to hear.

Further, audio streamed via the Internet is also often irreversibly encoded.

Meanwhile, LTE (Long Term Evolution) and the like have been proposed as communication standards of mobile communication. In so doing, a greater amount of information is able to be communicated.

### SUMMARY

For example, in a case where the sound quality of an audio signal deteriorates due to compression encoding or the like as described above, instead of the audio signal, it is desirable that an audio signal with little sound quality deterioration be output. Further, in a case where the audio signal is not an audio signal in the language desired by the user, instead of the audio signal, it is desirable that an audio signal in the language that the user desires be output. Further, in a case where the audio signal is not an audio signal of a type desired by the user, instead of the audio signal, it is desirable that an audio signal of a type desired by the user be output.

That is, in an audio signal processing device, it is desirable that a sub audio signal, such as an audio signal with little sound quality deterioration, an audio signal in a different language, or an audio signal of a different type, which is the same or similar to a main audio signal be output by being synchronized with the main audio signal which is a predetermined audio signal.

While a method of using a time code may be considered as a method of synchronizing a main audio signal with a sub audio signal, a time code is then set for all sub audio signals, taking time and effort in the editing of sub audio signals for a broadcast program or the like. Further, in a case where a sub audio signal is an audio signal for which a time code is not set such as a musical composition recorded on a server of a home, synchronization is not able to be performed.

It is desirable to output a sub audio signal that is the same or similar to a main audio signal by being synchronized with the main audio signal.

According to a first embodiment of the present technology, there is provided a signal processing device including: a feature amount calculation unit calculating the respective feature amount of a first audio signal obtained through a first communication pathway and a second audio signal obtained through a second communication pathway corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

A signal processing method, program, and a program recorded on a recording medium according to the first embodiment of the present technology corresponds to the signal processing device according to the first embodiment of the present technology.

According to the first embodiment of the present technology, the respectively feature amount of the first audio signal obtained through the first communication pathway and the second audio signal obtained through the second communication pathway corresponding to the first audio signal is calculated, the synchronization information of the first audio signal and the second audio signal is generated based on the calculated feature amounts, and the first audio signal and the second audio signal are synthesized based on the generated synchronization information.

According to a second embodiment of the present technology, there is provided a signal processing system including: a first signal processing device including a first transmission unit transmitting a first audio signal through a first communication pathway; a second signal processing device including a second transmission unit transmitting a second audio signal corresponding to the first audio signal through a second transmission pathway; and a third signal processing device including a first reception unit receiving the first audio signal transmitted from the first transmission unit, a second reception unit receiving the second audio signal transmitted from the second transmission unit, a feature amount calculation unit calculating the respective feature amount of the first audio signal received by the first reception unit and the second audio signal received by the second reception unit, an audio synchronization processing unit generating synchronization information of the first audio signal and the second audio signal based on the feature amounts calculated by the feature amount calculation unit, and an audio synthesis unit synthesizing the first audio signal with the second audio signal based on the synchronization information generated by the audio synchronization processing unit.

A signal processing method according to the second embodiment of the present technology corresponds to the signal processing system according to the second embodiment of the present technology.

According to the second embodiment of the present technology, the first signal processing device transmits the first audio signal through the first communication pathway, the third signal processing device receives the first audio signal from the first signal processing device, the second signal processing device transmits the second audio transmitted through the second communication pathway corresponding to the first audio signal, the third signal processing device receives the second audio signal from the second signal processing device, the respective feature amount of the received first audio signal and the second audio signal is calculated, the synchronization information of the first audio signal and the second audio signal is generated based on the calculated feature amounts, and the first audio signal and the second audio signal are synthesized based on the synchronization information.

According to a third embodiment of the present technology, there is provided a signal processing device including: a feature amount calculation unit calculating the respective feature amount of a first audio signal obtained through a predetermined communication pathway and a second audio signal read from a storage unit corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

A signal processing method, program, and a program recorded on a recording medium according to the third embodiment of the present technology corresponds to the signal processing device according to the third embodiment of the present technology.

According to the third embodiment of the present technology, the respective feature amount of the first audio signal obtained through a predetermined communication pathway and the second audio signal read from the storage unit corresponding to the first audio signal is calculated, the synchronization information of the first audio signal and the second audio signal is generated based on the calculated feature amounts, and the first audio signal and the second audio signal are synthesized based on the generated synchronization information.

According to a fourth embodiment of the present technology, there is provided a signal processing system including: a first signal processing device including a transmission unit transmitting a first audio signal through a predetermined communication pathway; a second signal processing device including a storage unit storing a second audio signal corresponding to the first audio signal; and a third signal processing device including a reception unit receiving the first audio signal transmitted from the transmission unit, an obtaining unit obtaining the second audio signal read from the storage unit, a feature amount calculation unit calculating the respective feature amount of the first audio signal received by the reception unit and the second audio signal obtained by the obtaining unit, an audio synchronization processing unit generating synchronization information of the first audio signal and the second audio signal based on the feature amounts calculated by the feature amount calculation unit, and an audio synthesis unit synthesizing the first audio signal with the second audio signal based on the synchronization information generated by the audio synchronization processing unit.

A signal processing method according to the fourth embodiment of the present technology corresponds to the signal processing system according to the fourth embodiment of the present technology.

According to the fourth embodiment of the present technology, the first signal processing device transmits the first audio signal through a predetermined communication pathway, the third signal processing device receives the first audio signal from the first signal processing device, the second signal processing device reads the second audio signal from the storage unit storing the second audio signal corresponding to the first audio signal, the third signal processing device obtains the second audio signal read by the second signal processing device, the respective feature amount of the received first audio signal and the read second audio signal is calculated, the synchronization information of the first audio signal and the second audio signal is generated based on the calculated feature amounts, and the first audio signal and the second audio signal are synthesized based on the generated synchronization information.

According to the first to fourth embodiments of the present technology, a sub audio signal that is the same or similar to the main audio signal is able to be output by being synchronized with the main audio signal.

### BRIEF DESCRIPTION OF THE DRAWINGS

FIG. 1 is a view illustrating a configuration example of a first embodiment of a signal processing system according to an embodiment of the present technology;

FIG. 2 is a block diagram illustrates a first configuration example of the television set of FIG. 1;

FIG. 3 is a block diagram illustrating a configuration example of a broadcast reception unit of FIG. 2;

FIG. 4 is a view describing a synthesized audio signal in the television set of FIG. 2;

FIG. 5 is a flowchart describing a program output process of the television set of FIG. 2;

FIG. 6 is a flowchart describing the details of a tuning process of FIG. 5;

FIG. 7 is a flowchart describing the details of a broadcast reception process of FIG. 5;

FIG. 8 is a flowchart describing the details of an output process of FIG. 5;

FIG. 9 is a flowchart describing the details of a sub audio signal reception process of FIG. 8;

FIG. 10 is a block diagram illustrating a second configuration example of the television set of FIG. 1;

FIG. 11 is a flowchart describing an output process of the television set of FIG. 10;

FIG. 12 is a flowchart describing the details of a sub audio signal reception process of FIG. 11;

FIG. 13 is a flowchart describing the details of a synthesis process of FIG. 11;

FIG. 14 is a view illustrating a configuration example of a second embodiment of a signal processing system according to an embodiment of the present technology;

FIG. 15 is a view illustrating a configuration example of a third embodiment of a signal processing system according to an embodiment of the present technology;

FIG. 16 is a block view illustrating a configuration example of the television set of FIG. 15;

FIG. 17 is a flowchart describing a program output process of the television set of FIG. 16;

FIG. 18 is a flowchart describing the details of a selection process of FIG. 17;

FIG. 19 is a flowchart describing the details of an obtaining process of FIG. 17;

FIG. 20 is a view illustrating a configuration example of a fourth embodiment of a signal processing system according to an embodiment of the present technology;

FIG. 21 is a block diagram illustrating a configuration example of the television set of FIG. 20;

FIG. 22 is a flowchart describing a broadcast reception process by a reception unit of FIG. 21;

FIG. 23 is a block diagram illustrating a configuration example of the hardware of a computer.

### DETAILED DESCRIPTION OF EMBODIMENTS

### First Embodiment

### Configuration Example of First Embodiment of Signal Processing System

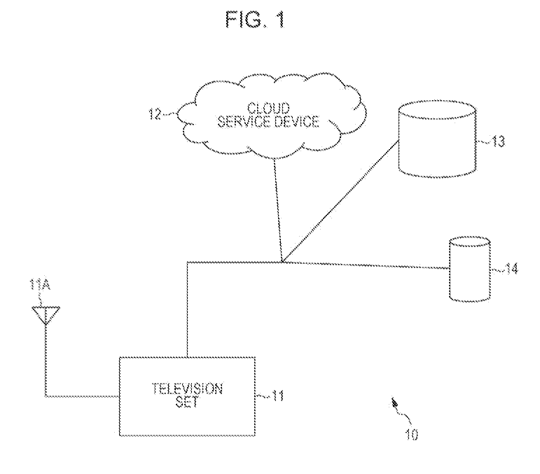

FIG. 1 is a view illustrating a configuration example of a first embodiment of a signal processing system according to an embodiment of the present technology.

A signal processing system 10 of FIG. 1 is configured by a television set 11 being connected to a cloud service device 12, a broadcast station server 13, and a home server 14 via a network.

The television set 11 functions as a signal processing device. The television set 11 receives a broadcast wave of a terrestrial digital broadcast transmitted from a broadcasting station as a signal processing device via an antenna 11A, for example, and obtains the broadcast signal transmitted through the broadcast wave. The broadcast signal includes a compression-encoded picture signal and main audio signal of a terrestrial digital broadcast, program information as attached information, and the like. The program information is information such as the supply source information indicating the cloud service device 12, the broadcast station server 13, or the home server 14 as the obtainment source of a sub audio signal which is the same or similar to the main audio signal, and specification information specifying a sub audio signal.

The television set 11 decodes the compression-encoded program information, and requests a sub audio signal from the cloud service device 12, the broadcast station server 13, or the home server 14 via a network based on the program information obtained as a result. The television set 11 receives the sub audio signal transmitted via the network according to the request.

The television set 11 decodes the compression-encoded picture signal and main audio signal of the terrestrial digital broadcast. The television set 11 generates a synthesized audio signal by synchronizing and synthesizing the main audio signal and the sub audio signal obtained as a result of the decoding. The television set 11 outputs the synthesized audio signal along with the decoded picture signal.

Here, in a case where the sub audio signal is not yet obtained when the picture signal is output due to the obtaining start timing or the transmission speed of the sub audio signal, the television set 11 may be on standby until the sub audio signal is obtained or may output the main audio signal until the sub audio signal is obtained. Here, the television set 11 outputs the main audio signal until the sub audio signal is obtained.

The cloud service device 12 is a signal processing device providing a cloud service, and stores the sub audio signal. The cloud service device 12 transmits the stored sub audio signal to the television set 11 according to a request by the television set 11.

The broadcast station server 13 is a server as a signal processing device managed by a broadcasting station of a terrestrial digital broadcast, and stores the sub audio signal. The broadcast station server 13 transmits the stored sub audio signal to the television set 11 according to a request by the television set 11.

The home server 14 is a server such as a DLNA (Digital Living Network Alliance) server or a server built into an audio apparatus as a signal processing device which the user of the television set 11 possesses, and stored the sub audio signal. The home server 14 transmits the stored sub audio signal to the television set 11 according to a request by the television set 11. Here, the home server 14 may be built into the television set 11.

Further, the sub audio signal may not be encoded using the same compression encoding method as the main audio signal, and may be an unencoded audio signal which is able to be reproduced by a typical television set. Further, while the sub audio signal may be encoded using lossless encoding or lossy encoding as necessary, an encoding method able to be decoded by the television set is selected as appropriate as the encoding method of the sub audio signal.

In the signal processing system 10 as described above, for example, in a case where the sub audio signal is an audio signal with little sound quality deterioration such as an audio signal compression encoded using a different compression encoding method from the main audio signal or an audio signal that is not compression encoded, the television set 11 is able to output a sub audio signal with higher sound quality instead of the main audio signal.

Further, in a case where the sub audio signal is an audio signal in a different language from the main audio signal, the television set 11 is able to output a sub audio signal in a different language instead of the main audio signal. Furthermore, in a case where the sub audio signal is a karaoke audio signal of a musical composition corresponding to the main audio signal, the television set 11 is able to output a karaoke sub audio signal instead of the main audio signal. Further, in a case where the sub audio signal is an audio signal as a BGM (Background Music) for the main audio signal, the television set 11 is able to reduce the BGM out of the audio corresponding to the main audio signal by synthesizing and outputting a sub audio signal as an antiphase of the main audio signal with the main audio signal.

Furthermore, in a case where the sub audio signal is an audio signal including the audio signal including the audio signal of a match recorded at a viewing seat behind the recording camera or at rooters seats at several locations as audio signals of different channels for each recording location, only the sub audio signal of a predetermined channel may be output instead of the main audio signal. In so doing, for example, only the audio signal of a rooters seat of a predetermined team out of the sub audio signals of a program for a match with two teams may be output.

### First Configuration Example of Television Set

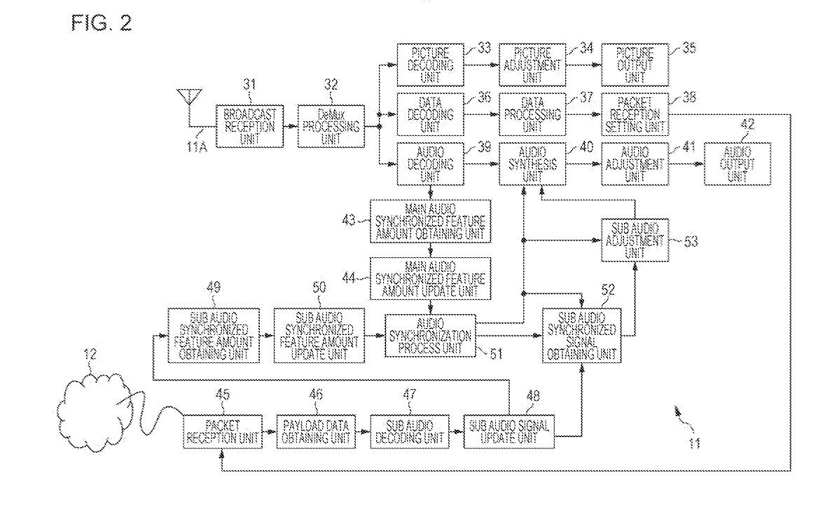

FIG. 2 is a block diagram illustrating a first configuration example of the television set 11 of FIG. 1.

The television set 11 of FIG. 2 receives an audio signal with little sound quality deterioration such as an audio signal compression encoded using a different compression encoding method from the main audio signal or an audio signal that is not compression encoded as a sub audio signal, and outputs the sub audio signal instead of the main audio signal.

Specifically, a broadcast reception unit 31 of the television set 11 performs a reception process of receiving a broadcast wave of a terrestrial digital broadcast via an antenna 11A, obtains a TS (Transport Stream) of the broadcast signal transmitted on the broadcast wave, and supplies the TS to a DeMux processing unit 32.

The DeMux processing unit 32 extracts a picture signal that is encoded (hereinafter referred to as an encoded picture signal), a main audio signal that is encoded (hereinafter referred to as an encoded main audio signal), and program information that is encoded (hereinafter referred to as encoded program information) from the TS supplied from the broadcast reception unit 31. The DeMux processing unit 32 supplies the encoded picture signal to a picture decoding unit 33, supplies the encoded program information to a data decoding unit 36, and supplies the encoded main audio signal to an audio decoding unit 39.

The picture decoding unit 33 decodes the encoded picture signal supplied from the DeMux processing unit 32, and supplies the picture signal obtained as a result to a picture adjustment unit 34. The picture adjustment unit 34 performs an adjustment process such as, for example, a lightness adjustment process, a coloring adjustment process, a brightness adjustment process, and a tilt adjustment process on the picture signal supplied from the picture decoding unit 33. The picture adjustment unit 34 functions as a display control unit, and displays a picture by supplying the adjustment processed picture signal to a picture output unit 35. The picture output unit 35 displays a picture based on a picture signal supplied from the picture adjustment unit 34.

The data decoding unit 36 decodes the encoded program information supplied from the DeMux processing unit 32, and supplies the program information obtained as a result to a data processing unit 37. The data processing unit 37 performs a process of updating the retained program information or the like when new program information is supplied from the data decoding unit 36. The data processing unit 37 supplies the updated program information to a packet reception setting unit 38.

The packet reception setting unit 38 supplies a control signal in which the supply source information of the program information supplied from the data processing unit 37 indicates the supply source of the sub audio signal as the connection destination as well as indicating specification information to a packet reception unit 45.

The audio decoding unit 39 decodes the encoded main audio signal supplied from the DeMux processing unit 32 and supplies the main audio signal obtained as a result to an audio synthesis unit 40 and a main audio synchronized feature amount obtaining unit 43.

The audio synthesis unit 40 synthesizes the main audio signal supplied from the audio decoding unit 39 with the sub audio signal supplied from a sub audio adjustment unit 53 at a predetermined ratio, and generates a synthesized audio signal. For example, if the synthesized audio signal is Am, the main audio signal is A1, the synthesis ratio of the main audio signal and the sub audio signal is C1:C2, and the sub audio signal is A2, the audio synthesis unit 40 generates the synthesized audio signal Am for each channel using the following Formula (I).

Am=C1×A1+C2×A2 (1)

According to Formula (1), for example, in a case where C1 is 0.5 and C2 is 0.5, the main audio signal and the sub audio signal are synthesized equally.

Here, the synthesis ratio C1:C2 in a case where a control signal outputting only the main audio signal is not supplied from an audio synchronization processing unit 51 may be determined at the supply source of the sub audio signal or may be determined by the user of the television set 11. Here, since the television set 11 outputs the sub audio signal instead of the main audio signal, in a case where a control signal to output only the main audio signal is not supplied from the audio synchronization processing unit 51, C1 is 0 and C2 is 1. In a case where a control signal to output only the main audio signal is supplied from the audio synchronization processing unit 51, C1 is 1 and C2 is 0.

In such a manner, in a case where either one of C1 or C2 is 0, the audio synthesis unit 40 may not perform the synthesis according to Formula (1) described above, and the main audio signal or the sub audio signal may be the synthesized audio signal as is. The audio synthesis unit 40 supplies the synthesized audio signal to an audio adjustment unit 41.

The audio adjustment unit 41 performs an adjust process such as a volume adjustment process, a left and right balance adjustment process, and a spread adding process on the synthesized audio signal supplied from the audio synthesis unit 40, and in a case where the amplitude of the synthesized audio signal Am after the adjustment process exceeds a threshold value (for example, 1.0), a process of clipping at the threshold value or the like is performed on the synthesized audio signal, for example, so that the amplitude is equal to or less than the threshold value. The audio adjustment unit 41 supplies the synthesized audio signal obtained as a result to an audio output unit 42.

The audio output unit 42 is formed of a digital amplifier, a D/A conversion unit, a speaker, and the like (all not shown). The digital amplifier of the audio output unit 42 adjusts the volume of the synthesized audio signal supplied from the audio adjustment unit 41, and the D/A conversion unit performs D/A conversion on the synthesized audio signal obtained as a result. The speaker of the audio output unit 42 outputs an audio corresponding to the analog signal obtained as a result of the D/A conversion.

The main audio synchronized feature amount obtaining unit 43 functions as a feature amount calculation unit, and obtains a predetermined feature amount from the main audio signal supplied from the audio decoding unit 39 for each analysis length (hereinafter referred to as an analysis frame) determined during the design. For example, in a case where the analysis frame length is 256 samples, the main audio synchronized feature amount obtaining unit 43 divides the main audio signal into bands of 256 samples, and obtains the gain information of the time signal of each band as the feature amount. Alternatively, the main audio synchronized feature amount obtaining unit 43 performs time frequency conversion for 256 samples at a time, and from the obtained frequency spectrums, obtains the frequency at which the frequency spectrum is the greatest, the shape of the power envelope of the frequency spectrums (for example, the magnitude of the peak power, the tilt from the peak power, the position of the second peak power, and the like), the basic frequency, and the like as the feature amount.

Here, the feature amount may be standardized, or may be two or more of the feature amounts described above. Further, the main audio synchronized feature amount obtaining unit 43 may extract the feature amount by moving by half the number of samples of the analysis frame length (for example, 128 samples), for example, rather than extracting the feature amount by moving by the analysis frame length. That is, the main audio synchronized feature amount obtaining unit 43 may extract the feature amount by overlapping the analysis frame length. The main audio synchronized feature amount obtaining unit 43 supplies the feature amount to a main audio synchronized feature amount update unit 44.

The main audio synchronized feature amount update unit 44 is formed of a circular buffer or the like, and accumulates a number of feature amounts determined during the design. Specifically, the main audio synchronized feature amount update unit 44 accumulates the feature amounts supplied from the main audio synchronized feature amount obtaining unit 43. At this time, in a case where a number of feature amount determined during the design has already accumulated, the oldest feature amount is updated to a feature amount supplied by the main audio synchronized feature amount obtaining unit 43. The main audio synchronized feature amount update unit 44 supplies the accumulated feature amounts to an audio synchronization processing unit 51.

The packet reception unit 45 performs an initialization process or the like according to a control signal supplied from the packet reception setting unit 38. Further, the packet reception unit 45 connects with the cloud service device 12 as the connection destination according to the control signal, and requests the sub audio signal specified by the specification information to the cloud service device 12. Furthermore, the packet reception unit 45 receives and temporarily retains packets of the sub audio signal transmitted from the cloud service device 12 according to the request.

A payload data obtaining unit 46 obtains and retains payload data from the packets accumulated in the packet reception unit 45. Further, the payload data obtaining unit 46 obtains a sub audio signal that is encoded (hereinafter referred to as an encoded sub audio signal) or an unencoded sub audio signal from the payload data, and supplies the obtained sub audio signal to a sub audio decoding unit 47.

In a case where an encoded sub audio signal is supplied from the payload data obtaining unit 46, the sub audio decoding unit 47 decodes the encoded sub audio signal and supplies the sub audio signal obtained as a result to a sub audio signal update unit 48. Further, in a case where a sub audio signal is supplied from the payload data obtaining unit 46, the sub audio decoding unit 47 supplies the sub audio signal to the sub audio signal update unit 48 as is.

The sub audio signal update unit 48 is formed of a circular buffer or the like, and accumulates a number of sub audio signals determined during the design. The sub audio signal update unit 48 supplies the accumulated sub audio signals to a sub audio synchronized feature amount obtaining unit 49.

The sub audio synchronized feature amount obtaining unit 49 functions as a feature amount calculation unit, and similarly to the main audio synchronized feature amount obtaining unit 43, obtains a predetermine feature amount for each analysis frame from the sub audio signals supplied from the sub audio signal update unit 48, and supplies the feature amount to a sub audio synchronized feature amount update unit 50. Here, the extraction target of feature amounts may be only the sub audio signals of a channel designated by a broadcast station in advance out of the sub audio signals.

Similarly to the main audio synchronized feature amount update unit 44, the sub audio synchronized feature amount update unit 50 is formed of a circular buffer or the like, and accumulates a number of feature amounts determined during the design. The sub audio synchronized feature amount update unit 50 supplies the accumulated feature amounts to an audio synchronization processing unit 51.

The audio synchronization processing unit 51 calculates a correction amount for the sub audio signal to synchronize with the main audio signal as synchronization information for the main audio signal and the sub audio signal based on the feature amounts supplied from the main audio synchronized feature amount update unit 44 and the sub audio synchronized feature amount update unit 50.

Specifically, for example, the audio synchronization processing unit 51 calculates the correlation value between vectors of the feature amount of each analysis frame of the main audio signal and the vectors of the feature amount of each analysis frame of the sub audio signal. Furthermore, the audio synchronization processing unit 51 determines that there is a synchronization position in a case where the maximum value of the correlation value is equal to or greater than a threshold value (for example, 0.7) determined during the design, and calculates the number of samples between the leading positions of the analysis frames (hereinafter referred to as a synchronization analysis frame) of the main audio signal and the sub audio signal corresponding to the correlation value as the correction amount. On the other hand, in a case where the maximum value of the correlation value is less than the threshold value, it is determined that there is no synchronization position.

In a case where the correction amount is calculated, the audio synchronization processing unit 51 supplies the correction amount to a sub audio synchronized signal obtaining unit 52. On the other hand, in a case where it is determined that there is no synchronization position or in a case where a feature amount of the sub audio signal is not supplied from the sub audio synchronized feature amount update unit 50, the audio synchronization processing unit 51 supplies a control signal to not perform processing to the sub audio synchronized signal obtaining unit 52 and the sub audio adjustment unit 53. Further, the audio synchronization processing unit 51 supplies a control signal to output only the main audio signal to the audio synthesis unit 40. In so doing, an audio corresponding to the main audio signal is output along with the picture in a case where there is no synchronization position between the main audio signal and the sub audio signal or in a case where a sub audio signal is not obtained.

Here, in a case where C1 is not 0 or the like, the audio synchronization processing unit 51 may calculate the correction amount in units of samples instead of in units of analysis frames.

In such a case, the audio synchronization processing unit 51 calculates the correlation value of signal waveforms of audio signals of a fixed period of time (for example, of one analysis frame) determined during the design centered around the synchronization analysis frame. Furthermore, it is determined that there is a synchronization position in a case where the maximum value of the correlation value is equal to or greater than a threshold value determined during the design, and the audio synchronization processing unit 51 calculates the number of samples between the positions of the samples of the main audio signal and the sub audio signal corresponding to the correlation value (hereinafter referred to as synchronization samples) as the correction amount. On the other hand, in a case where the correlation value is less than the threshold value, it may be determined that there is no synchronization position, or the number of samples between the leading positions of the synchronization analysis frames may be calculated as the correction amount.

Here, the audio synchronization processing unit 51 may calculate the correlation values between the signal waveforms of audio signals in units of predetermined bands (for example, 16 bands). In such a case, the audio synchronization processing unit 51 divides the main audio signal and the sub audio signal in units of predetermined bands, and calculates the correlation value of the band divided signals obtained as a result. Furthermore, the position of the synchronization sample is the position of the sample of the main audio signal and the sub audio signal corresponding to the maximum value of the correlation value of all bands, the position of the sample of the main audio signal and the sub audio signal at which the maximum value of the correlation value for each predetermined band is the greatest, or the average position of the samples of the main audio signal and the sub audio signal corresponding to the maximum value of the correlation value of each predetermined band.

In such a manner, by finding the position of the synchronization sample using the correlation value of each predetermined band, the audio synchronization processing unit 51 is able to obtain a high-precision correction amount even in a case where audio signals causing the correlation value between the main audio signal and the sub audio signal to be small in specific bands are included.

The sub audio synchronized signal obtaining unit 52 reads the sub audio signal from the sub audio signal update unit 48 based on the correction amount supplied from the audio synchronization processing unit 51.

The sub audio adjustment unit 53 performs a default adjustment process on the sub audio signal supplied from the sub audio synchronized signal obtaining unit 52.

For example, in a case where the sub audio signal is an audio signal with little sound quality deterioration including an audio signal of the main audio of a television drama, a movie, or the like (for example, lines) and an audio signal of the BGM as audio signals of different channels, the sub audio adjustment unit 53 performs an adjustment process such as a process of lowering the level or a process of hypothetically positioning the BGM at a position with depth by folding in a Head-Related Transfer Function (HRTF) or the like on the audio signal of the BGM channel. Further, the sub audio adjustment unit 53 performs an adjustment process such as a process of raising the level or a process of hypothetically positioning the main audio at the front face of the television set 11 by folding in the HRTF or the like on the audio signal of the main audio channel. In so doing, for example, the main audio is emphasized, and the main audio is easier to hear.

Here, in a case where the audio output unit 42 is a multichannel reproduction system such as a 5.1ch theater system, the sub audio adjustment unit 53 may perform an adjustment process such as a process of folding in the HRTF, for example, by making the BGM channel the rear speaker channel and making the main audio channel the front speaker channel.

Further, in a case where the sub audio signal is an audio signal with little sound quality deterioration including the audio signal of a match recorded at a viewing seat behind the recording camera or at rooters seats at several locations as audio signals of different channels for each recording location, an adjustment process such as a process of hypothetically positioning to the back by folding in the HRTF for each channel or the like is performed. In so doing, the realism of the match is improved.

Here, in a case where the audio output unit 42 is a multichannel reproduction system, the sub audio adjustment unit 53 may perform an adjustment process such as, for example, a process of folding in the HRTF with all channels as rear speaker channels. The sub audio adjustment unit 53 may supply the adjustment processed audio signal to the audio synthesis unit 40.

Here, while there is constantly a sub audio signal and the main audio signal and the sub audio signal are constantly output by being synthesized in the present specification, there may not constantly be a sub audio signal. Further, while the expansion audio function that is a function of synthesizing and outputting the main audio signal and the sub audio signal is constantly effective in the present specification, whether or not to obtain the sub audio signal may be determined according to an instruction from the user to make the expansion audio function effective or ineffective. Furthermore, the audio decoding unit 39 may supply the audio signal to the main audio synchronized feature amount obtaining unit 43 according to the existence of a sub audio signal or an instruction from the user to make the expansion audio function effective or ineffective.

### Configuration Example of Broadcast Reception Unit

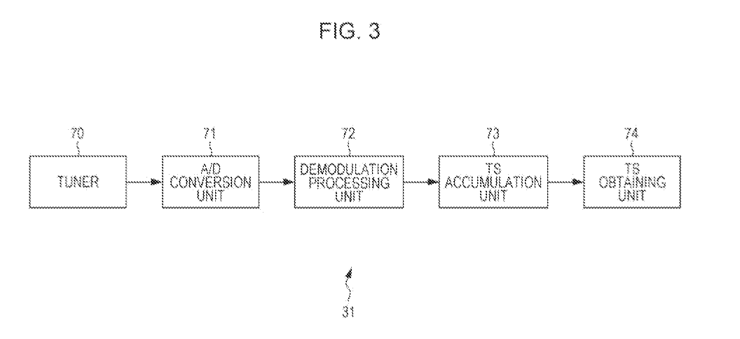

FIG. 3 is a block diagram illustrating a configuration example of the broadcast reception unit 31 of FIG. 2.

The broadcast reception unit 31 of FIG. 3 is configured by a tuner 70, an A/D conversion unit 71, a demodulation processing unit 72, a TS accumulation unit 73, and a TS obtaining unit 74.

The tuner 70 extracts a broadcast wave of a predetermined channel from the broadcast wave received via the antenna 11A, and supplies the broadcast wave to the A/D conversion unit 71. The A/D conversion unit 71 performs A/D conversion on the broadcast wave supplied from the tuner 70, and supplies the digital signal obtained as a result to the demodulation processing unit 72.

The demodulation processing unit 72 demodulates the digital signal supplied from the A/D conversion unit 71, and supplies the TS of the broadcast signal obtained as a result to the TS accumulation unit 73. The TS accumulation unit 73 is formed of a circular buffer or the like, and temporarily accumulates the TS supplied from the demodulation processing unit 72. The TS obtaining unit 74 obtains a TS from the TS accumulation unit 73 at fixed time intervals, and supplies the TS to the DeMux processing unit 32 of FIG. 2.

Description of Synthesized Audio Signal

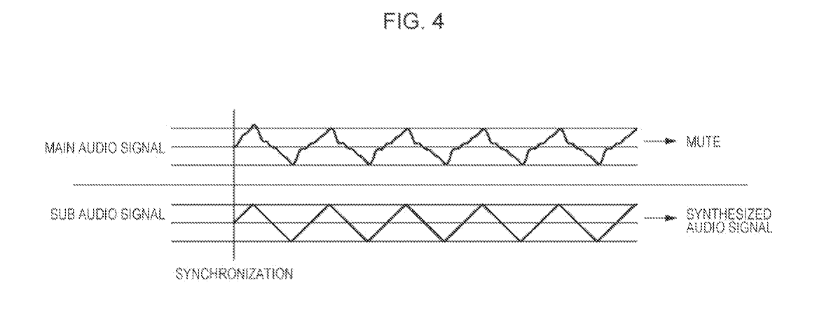

FIG. 4 is a view describing a synthesized audio signal in the television set 11 of FIG. 2.

As illustrated in FIG. 4, the sub audio signal is an audio signal with little sound quality deterioration. In the audio synthesis unit 40, the main audio signal is muted, and the sub audio signal synchronized with the main audio signal is output as a synthesized audio signal.

### Description of First Example of Process of Television Set

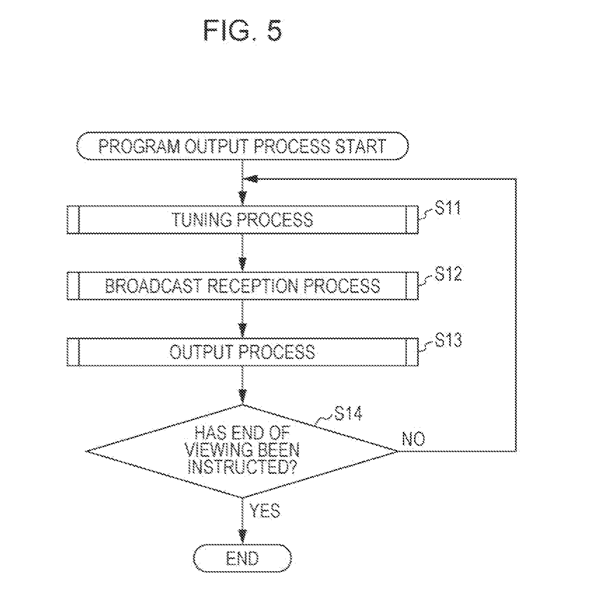

FIG. 5 is a flowchart describing a program output process of the television set 11 of FIG. 2. The program output process is started, for example, when the user operates an input unit (not shown) and instructs the start of viewing to the television set 11.

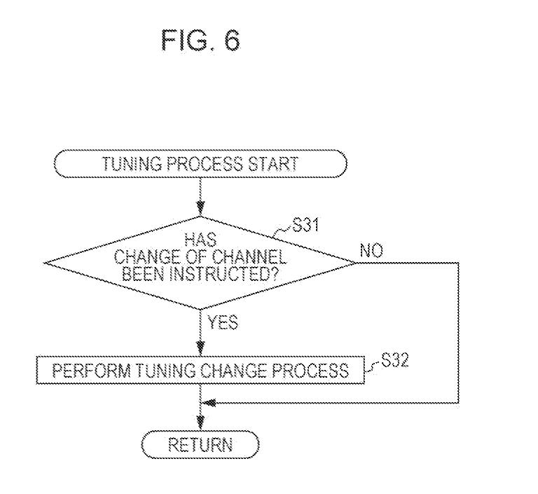

The broadcast reception unit 31 of the television set 11 performs a tuning process of tuning to the reception target channel in step S11 of FIG. 5. Details of the tuning process will be described with reference to FIG. 6 described later.

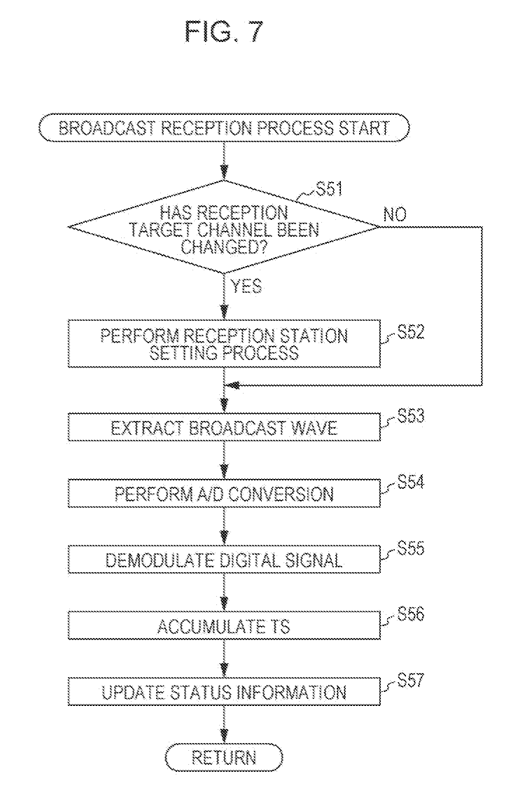

The broadcast reception unit 31 performs a broadcast reception process of receiving a broadcast signal of a predetermine channel in step S12. Details of the broadcast reception process will be described with reference to FIG. 7 described later.

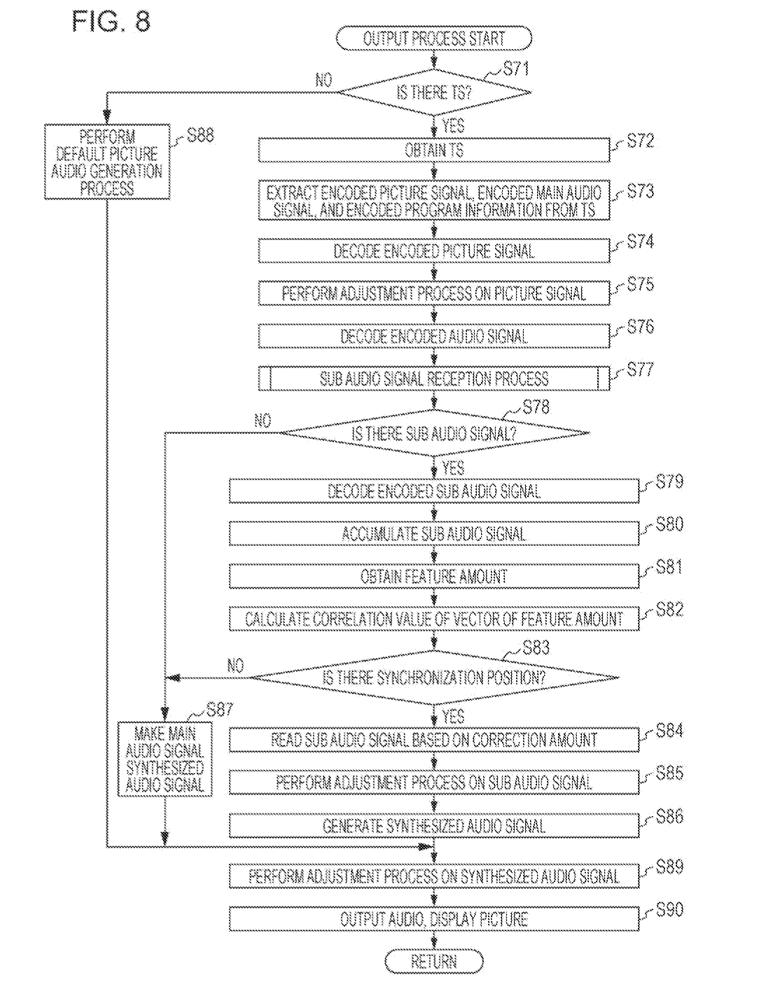

The television set 11 performs an output process of outputting a picture signal and a synthesized audio signal in step S13. Details of the output process will be described with reference to FIG. 8 described later.

The television set 11 determines whether the user has operated an input unit (not shown) and instructed the end of viewing in step S14. In a case where it is determined in step S14 that the user has not instructed the end of viewing, the process returns to step S11 and the processes of steps S11 to S14 are repeated.

On the other hand, in a case where it is determined in step S14 that the user has instructed the end of viewing, the process is ended.

FIG. 6 is a flowchart describing the details of the tuning process of step S11 of FIG. 5.

The tuner 70 (FIG. 3) of the broadcast reception unit 31 determines whether the user has operated an input unit (not shown) and instructed a change in the channel viewed in step S31 of FIG. 6. Here, during the process of the first step S31, it is determined that the user has instructed a change in the channel viewed.

In a case where it is determined in step S31 that the user has instructed a changed in the channel viewed, the tuner 70 performs a turning change process in step S32 of making a change flag which is being retained indicating that the reception target channel has been changed effective and turning off a ready flag indicating that reception preparations have been made. Furthermore, the process returns to step S11 of FIG. 5 and proceeds to step S12.

On the other hand, in a case where it is determined in step S31 that the user has not instructed a change in the channel viewed, the process returns to step S11 of FIG. 5 and proceeds to step S12.

FIG. 7 is a flowchart describing the details of the broadcast reception process of step S12 of FIG. 5.

The tuner 70 (FIG. 3) of the broadcast reception unit 31 determines whether the reception target channel has been changed based on the change flag in step S51 of FIG. 7. In a case where it is determined in step S51 that the reception target channel has been changed, the process proceeds to step S52.

The tuner 70 performs a process of setting the tuned channel to a channel instructed by the user, an initialization process, or the like as a reception station setting process in step S52. Furthermore, the tuner 70 makes the change flag ineffective, turns on the ready flag, and advances the process to step S53.

On the other hand, in a case where it is determined in step S51 that the reception target channel has not been changed, the process proceeds to step S53.

In step S53, the tuner 70 extracts the broadcast wave of a channel set as the channel turned in step S52 from the broadcast wave received via the antenna 11A, and supplies the broadcast wave to the A/D conversion unit 71.

The A/D conversion unit 71 performs A/D conversion on the broadcast wave supplied from the tuner 70, and supplies the digital signal obtained as a result to the demodulation processing unit 72 in step S54.

The demodulation processing unit 72 demodulates the digital signal supplied from the A/D conversion unit 71 in step S55.

The demodulation processing unit 72 supplies and accumulates the TS of the broadcast signal obtained as a result of the demodulation at the TS accumulation unit 73 in step S56.

The TS obtaining unit 74 updates the status information of the retained TS accumulated in the TS accumulation unit 73 (for example, the amount of TS yet to be read, or the like) in step S57. Furthermore, the process returns to step S12 of FIG. 5 and proceeds to step S13.

FIG. 8 is a flowchart describing the details of an output process of step S13 of FIG. 5.

The DeMux processing unit 32 verifies the status information of the TS retained by the TS obtaining unit 74 of FIG. 3 and determines whether there is TS yet to be read in step S71 of FIG. 8. In a case where it is determined in step S71 that there is TS yet to be read, the DeMux processing unit 32 obtains the TS from the TS obtaining unit 74 in step S72.

The DeMux processing unit 32 extracts an encoded picture signal, an encoded main audio signal, and encoded program information from the TS obtained from the TS obtaining unit 74 in step S73. The DeMux processing unit 32 supplies the encoded picture signal to the picture decoding unit 33, supplies the encoded program information to the data decoding unit 36, and supplies the encoded main audio signal to the audio decoding unit 39.

The picture decoding unit 33 decodes the encoded picture signal supplied from the DeMux processing unit 32 and supplies the picture signal obtained as a result to the picture adjustment unit 34 in step S74. The picture adjustment unit 34 performs an adjustment process on the picture signal supplied from the picture decoding unit 33, and supplies the picture signal to the picture output unit in step S75.

The audio decoding unit 39 decodes the encoded main audio signal supplied from the DeMux processing unit 32 and supplies the main audio signal obtained as a result to the audio synthesis unit 40 and the main audio synchronized feature amount obtaining unit 43 in step S76.

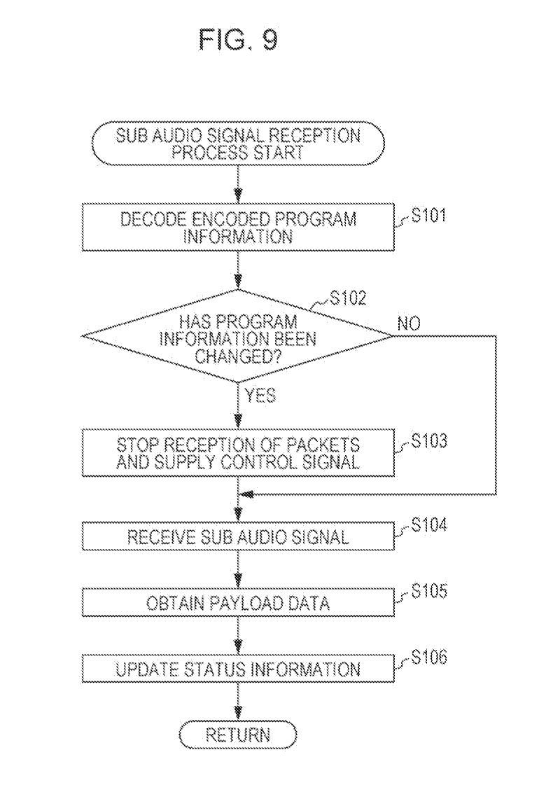

The television set 11 performs a sub audio signal reception process of receiving the sub audio signal in step S77. Details of the sub audio signal reception process will be described with reference to FIG. 9 described later. After the process of step S77, the process proceeds to step S78.

The sub audio decoding unit 47 determines whether or not there is a sub audio signal yet to be read in the payload data obtaining unit 46 in step S78. In a case where it is determined in step S78 that there is a sub audio signal, the sub audio decoding unit 47 decodes the encoded sub audio signal in step S79 in a case where the sub audio signal is encoded. Further, in a case where the sub audio signal is not encoded, the sub audio decoding unit 47 leaves the sub audio signal as is.

The sub audio decoding unit 47 supplies and accumulates the sub audio signal at the sub audio signal update unit 48 in step S80. The main audio synchronized feature amount obtaining unit 43 and the sub audio synchronized feature amount obtaining unit 49 respectively obtain a predetermined feature amount for each analysis frame from the main audio signal from the audio decoding unit 39 and the sub audio signal from the sub audio signal update unit 48 in step S81. Furthermore, the main audio synchronized feature amount obtaining unit 43 supplies and accumulates the obtained feature amount at the main audio synchronized feature amount update unit 44, and the sub audio synchronized feature amount obtaining unit 49 supplies and accumulates the obtained feature amount at the sub audio synchronized feature amount update unit 50.

The audio synchronization processing unit 51 calculates the correlation value between the vectors of the feature amount of each analysis frame of the main audio signal and the vectors of the feature amount of each analysis frame of the sub audio signal in step S82.

In step S83, the audio synchronization processing unit 51 determines whether there is a synchronization position between the main audio signal and the sub audio signal, that is, whether the maximum value of the correlation value calculated in step S82 is equal to or greater than a predetermined threshold value.

In a case where it is determined in step S83 that there is a synchronization position between the main audio signal and the sub audio signal, the audio synchronization processing unit 51 calculates the number of samples between the leading positions of the synchronization analysis frame as the correction amount. Furthermore, the audio synchronization processing unit 51 supplies the correction amount to the sub audio synchronized signal obtaining unit 52.

The sub audio synchronized signal obtaining unit 52 reads the sub audio signal from the sub audio signal update unit 48 based on the correction amount supplied from the audio synchronization processing unit 51 in step S84.

The sub audio adjustment unit 53 performs an adjustment process on the sub audio signal supplied from the sub audio synchronized signal obtaining unit 52 and supplies the sub audio signal to the audio synthesis unit 40 in step S85.

The audio synthesis unit 40 synthesizes the main audio signal supplied from the audio decoding unit 39 and the sub audio signal supplied from the sub audio adjustment unit 53 at a predetermine ratio and generates a synthesized audio signal in step S86. Furthermore, the audio synthesis unit supplies the synthesized audio signal to the audio adjustment unit 41 and advances the process to step S89.

On the other hand, in a case where it is determined in step S71 that there is no TS yet to be read, the television set 11 performs a default picture audio synthesis process of generating a predetermined picture and audio in step S88. Specifically, the picture adjustment unit 34 generates a picture signal such as the station number of the reception target channel, the title of the program, or a message indicating mid-preparation for output, and supplies the picture signal to the picture output unit 35. Further, the audio synthesis unit 40 generates an audio signal such as a message indicating mid-preparation for output, and supplies the audio signal to the audio adjustment unit 41. Furthermore, the process proceeds to step S89.

Further, in a case where it is determined in step S78 that there is not sub audio signal yet to be read by the payload data obtaining unit 46, or in a case where it is determined in step S83 that there is no synchronization position between the main audio signal and the sub audio signal, the audio synchronization processing unit 51 supplies a control signal to not perform processing to the sub audio synchronized signal obtaining unit 52 and the sub audio adjustment unit 53. Further, the audio synchronization processing unit 51 supplies a control signal to output only the main audio signal to the audio synthesis unit 40, and advances the process to step S87.

The audio synthesis unit 40 supplies the main audio signal supplied from the audio decoding unit 39 as a synthesized audio signal to the audio adjustment unit 41 in step S87, and advances the process to step S89.

The audio adjustment unit 41 performs an adjustment process on the synthesized audio signal supplied from the audio synthesis unit 40 and supplies the synthesized audio signal to the audio output unit 42 in step S89.

The picture output unit 35 displays a picture based on the picture signal supplied from the picture adjustment unit 34 in step S90. Further, the audio output unit 42 adjusts the volume of the synthesized audio signal supplied from the audio adjustment unit 41 and performs D/A conversion, and outputs the audio corresponding to an analog signal obtained as a result. Furthermore, the process returns to step S13 of FIG. 5 and proceeds to step S14.

Here, the extraction process of step S73, the decoding processes of steps S74, S76, and S79, the feature amount obtaining process of step S81, the correlation value calculation process of step 382, and the like of FIG. 8 may be processed to be parallel.

FIG. 9 is a flowchart describing the details of the sub audio signal reception process of step S77 of FIG. 8.

The data decoding unit 36 decodes the encoded program information supplied from the DeMux processing unit 32 and supplies the program information obtained as a result to the data processing unit 37 in step S101 of FIG. 9.

The data processing unit 37 determines in step S102 whether the program information has been changed, that is, whether the program information supplied from the data decoding unit 36 is different from the retained program information, or whether the program information is the first program information. In a case where it is determined in step S102 that the program information has been changed, the data processing unit 37 performs a process of updating the retained program information or the like. Furthermore, the data processing unit 37 supplies the update program information to the packet reception setting unit 38, and advances the process to step S103.

In step S103, the packet reception setting unit 38 causes the packet reception unit 45 to stop the reception of packets, indicates the supply source of the sub audio signal indicated by the supply source information of the program information supplied from the data processing unit 37 as the connection destination, and supplies a control signal indicating specification information to the packet reception unit 45. In so doing, the packet reception unit 45 stops the reception of packets and performs an initialization process or the like. Further, the packet reception unit 45 connects to the cloud service device 12 as the connection destination indicated by the control signal, and requests the sub audio signal specified by the specification information from the cloud service device 12.

On the other hand, in a case where it is determined in step S102 that the program information has not been changed, the process proceeds to step S104.

The packet reception unit 45 receives and temporarily retains packets of the sub audio signal specified by the specification information from the connection destination in step S104.

The payload data obtaining unit 46 obtains and retains the payload data from the packets accumulated at the packet reception unit 45 in step S105.

The payload data obtaining unit 46 updates the status information (for example, the amount of payload data yet to be read, or the like) of the retained payload data in step S106. Furthermore, the process returns to step S77 of FIG. 8 and proceeds to step S78. Determination is made based on the status information in step S78.

In such a manner, the television set 11 of FIG. 2 extracts feature amounts of the main audio signal and the sub audio signal, generates synchronization information based on the feature amounts, and synthesizes the main audio signal with the sub audio signal based on the synchronization information. In so doing, since the sub audio signal is able to be output by being synchronized with the main audio signal, the audio of the program is able to be changed to an audio with little sound quality deterioration naturally.

Here, while the television set 11 of FIG. 2 receives the sub audio signal from the cloud service device 12, the same is also true in a case where the sub audio signal is received from the broadcast station server 13 or the home server 14 except that the connection destination is the broadcast station server 13 or the home server 14.

### Second Configuration Example of Television Set

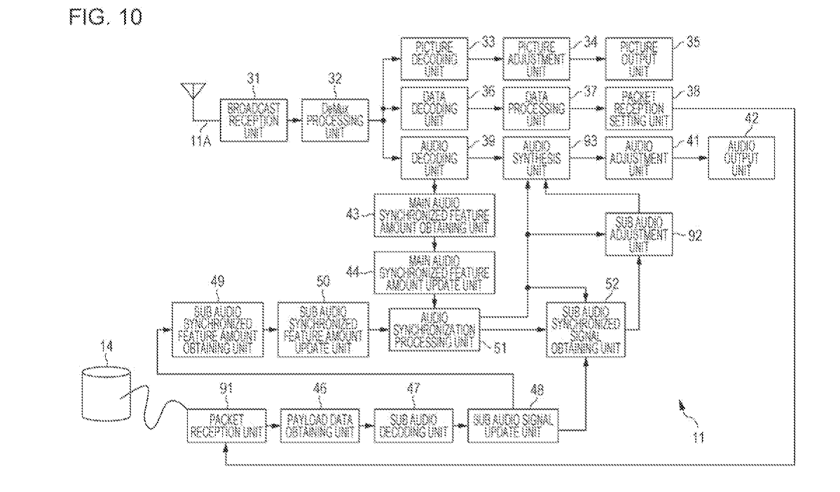

FIG. 10 is a block diagram illustrating a second configuration example of the television set 11 of FIG. 1.

Of the configurations illustrated in FIG. 10, the same symbols are given to configurations that are the same as the configurations of FIG. 2. Overlapping description will be omitted as appropriate.

The configuration of the television set 11 of FIG. 10 differs from the configuration of FIG. 2 mainly in that a packet reception unit 91, a sub audio adjustment unit 92, and an audio synthesis unit 93 are provided instead of the packet reception unit 45, the sub audio adjustment unit 53, and the audio synthesis unit 40.

The television set 11 of FIG. 10 receives a karaoke audio signal for a musical composition corresponding to the main audio signal or the audio signal of a musical composition as the sub audio signal from the home server 14, and synthesizes the sub audio signal with the main audio signal to be output. Here, the musical composition information (for example, the title, the title of a program, or the like) specifying the musical composition corresponding to the main audio signal is used as the specification information.

Specifically, the packet reception unit 91 of the television set 11 performs an initialization process or the like according to a control signal supplied from the packet reception setting unit 38. Further, the packet reception unit 91 functions as a reading control unit, and controls the reading of the sub audio signal by connecting to the home server 14 as the connection destination and requesting the home server 14 for the sub audio signal of a musical composition specified by the musical composition information according to the control signal.

In so doing, the home server 14 searches for the sub audio signal of the musical composition specified by the musical composition information. At this time, in a case where the musical composition information is the title of a program or the like, the home server 14 searches for the title of the musical composition or the like being used in the program from other servers via a network, and searches for the sub audio signal of the musical composition specified by the title or the like. The home server 14 reads and transmits the sub audio signal obtained as a result of the search to the television set 11.

The packet reception unit 91 functions as an obtaining unit, and obtains and temporarily retains packets of the sub audio signal transmitted from the home server 14 according to the request.

The sub audio adjustment unit 92 performs a default adjustment process on the sub audio signal supplied from the sub audio synchronized signal obtaining unit 52. For example, in a case where the sub audio signal is an audio signal including the audio signal for each musical performance part as audio signals of different channels, the sub audio adjustment unit 92 performs an adjustment process such as a process of muting the audio signals of musical performance parts selected by the user or a process of improving realism by positioning each musical performance part to a predetermined hypothetical position by folding in the HRTF or the like.

Here, in a case where the audio output unit 42 is a multichannel reproduction system, the sub audio adjustment unit 92 may perform a process of multiplying, for each channel, a coefficient determined in advance according to the positions of speakers corresponding to the channels with the sub audio signal as an adjustment process. The sub audio adjustment unit 92 supplies the adjustment processed audio signal to the audio synthesis unit 93.

Similarly to the audio synthesis unit 40 of FIG. 2, the audio synthesis unit 93 synthesizes the main audio signal supplied from the audio decoding unit 39 with the sub audio signal supplied from the sub audio adjustment unit 92 at a predetermined ratio, and generates a synthesized audio signal.

Here, in a case where the sub audio signal is a karaoke musical composition audio signal, C1 in a case where a control signal to output only the main audio signal is not supplied from the audio synchronization processing unit 51 is 0, and C2 is 1.

On the other hand, in a case where the main audio signal is an audio signal including the audio signal of the BGM and the audio signal of the main audio as audio signals of different channels, and the sub audio signal is the audio signal of the BGM corresponding to the main audio signal, C1 and C2 in a case where a control signal to output only the main audio signal is not supplied from the audio synchronization processing unit 51 are 0.5. However, in such a case, the sub audio signal is the antiphase of the main audio signal, and synthesis is performed with the sampling frequency converted so that the sampling frequency of the sub audio signal is the same as the sampling frequency of the main audio signal. The audio synthesis unit 93 supplies the synthesized audio signal to the audio adjustment unit 41.

### Description of Second Example of Process of Television Set

Since the program output process of the television set 11 of FIG. 10 is the same as the program output process of FIG. 5 except for the output process of step S13 of FIG. 5, only the output process will be described.

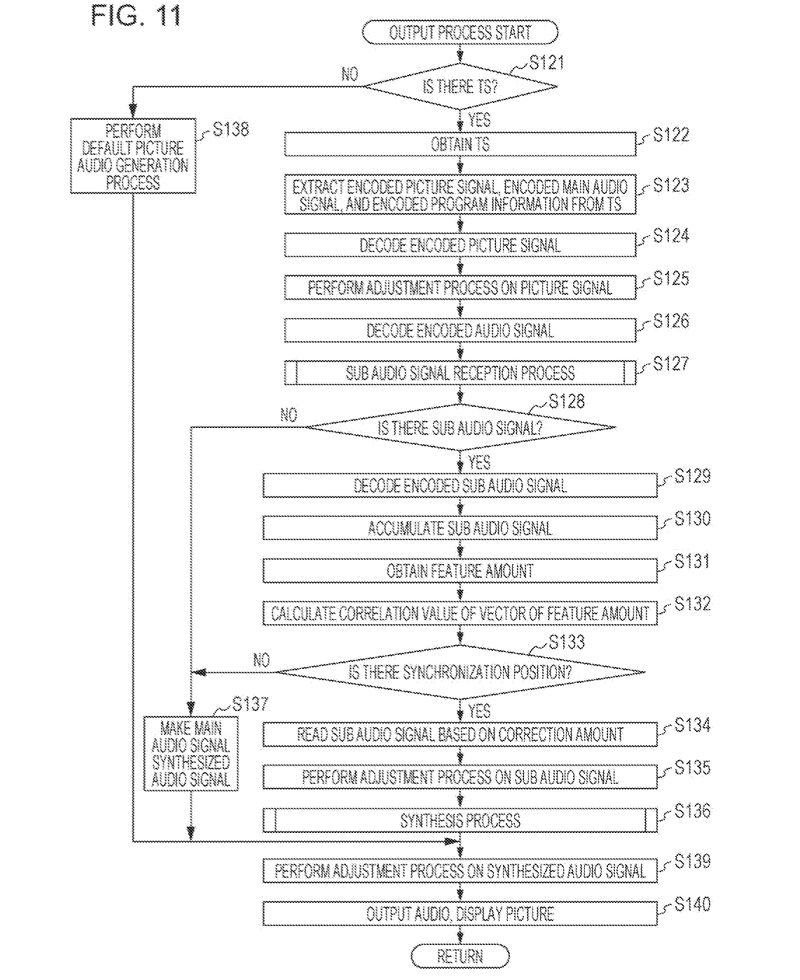

FIG. 11 is a flowchart describing the details of the output process of the television set 11 of FIG. 10.

Since the processes of steps S121 to S126 of FIG. 11 are the same as the processes of steps S71 to S76 of FIG. 8, description will be omitted.

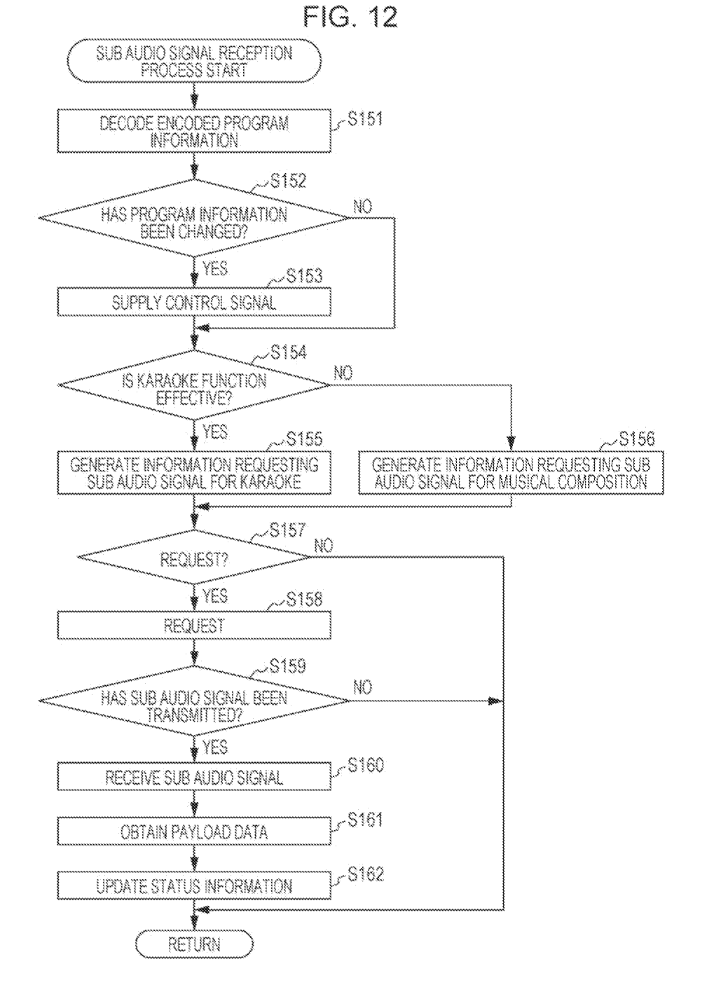

The television set 11 of FIG. 10 performs a sub audio signal reception process in step S127. Details of the sub audio signal reception process will be described with reference to FIG. 12 described later. After the process of step S127, the process proceeds to step S128.

Since the processes of steps S128 to S135 are the same as the processes of steps S78 to S85 of FIG. 8, description will be omitted.

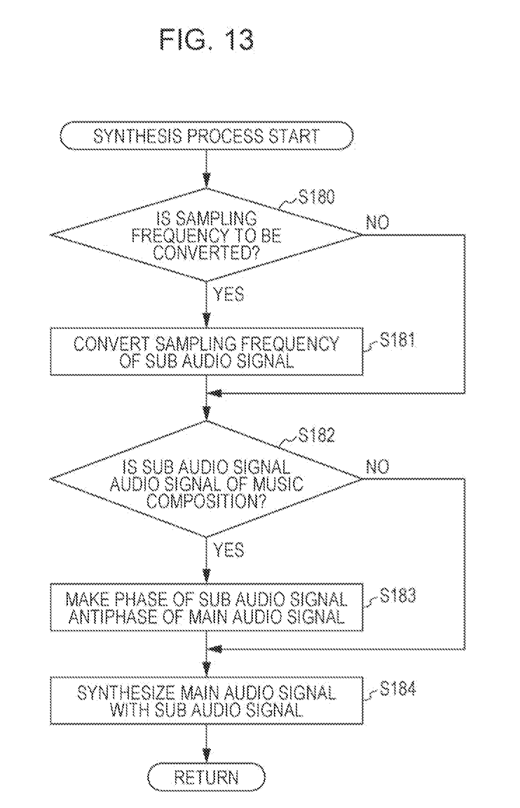

The audio synthesis unit 93 performs a synthesis process of synthesizing the main audio signal supplied from the audio decoding unit 39 with the sub audio signal supplied from the sub audio adjustment unit 92 in step S136. Details of the synthesis process will be described with reference to FIG. 13 described later. After the process of step S136, the process proceeds to step S139.

Since the processes of steps S137 to S140 are the same as the processes of steps S87 to S90 of FIG. 8, description will be omitted.

FIG. 12 is a flowchart describing the details of the sub audio signal reception process of step S127 of FIG. 11.

In step S151 of FIG. 12, the data decoding unit 36 decodes the encoded program information supplied from the DeMux processing unit 32, and supplies the program information obtained as a result to the data processing unit 37.

The data processing unit 37 determines whether the program information has been changed in step S152. In a case where it is determined in step S152 that the program information has been changed, the data processing unit 37 performs a process of updating the retained program information, or the like. Furthermore, the data processing unit 37 supplies the update program information to the packet reception setting unit 38, and advances the process to step S153.

The packet reception setting unit 38 indicates the supply source of the sub audio signal indicated by the supply source information of the program information supplied from the data processing unit 37 as the connection destination, and supplies a control signal indicating the specification information to the packet reception unit 91 in step S153. Furthermore, the process proceeds to step S154.

On the other hand, in a case where it is determined in step S152 that the program information has not been changed, the process proceeds to step S154.

The packet reception unit 91 determines whether or not the karaoke function is effective in step S154. Specifically, the user is able to give an instruction to make a karaoke function of outputting a karaoke sub audio signal instead of the main audio signal effective or ineffective by operating an input unit (not shown). Furthermore, the karaoke function is made effective or ineffective according to the instruction by the user. The packet reception unit 91 determines whether or not the karaoke function is effective.

In a case where it is determined in step S154 that the karaoke function is effective, the process proceeds to step S155. In step S155, the packet reception unit 91 generates information requesting a karaoke sub audio signal for a musical composition specified by musical composition information by the home server 14, and advances the process to step S157.

On the other hand, in a case where it is determined in step S154 that the karaoke function is not effective, the process proceeds to step S156. In step S156, the packet reception unit 91 generates information requesting a sub audio signal for a musical composition specified by musical composition information by the home server 14, and advances the process to step S157.

The packet reception unit 91 determines whether or not to request a sub audio signal, that is, whether or not the effectiveness of the karaoke function or the program information has been changed, in step S157. In a case where it is determined in step S157 that the sub audio signal is requested, the packet reception unit 91 performs an initialization process or the like.

Furthermore, in step S158, the packet reception unit 91 requests the home server 14 for the sub audio signal by transmitting the information generated in step S155 or S156 to the home server 14.

In step S159, the packet reception unit 91 determines whether or not the sub audio signal has been transmitted from the home server 14 according to the request. In a case where it is determined in step S159 that the sub audio signal has been transmitted from the home server 14, the process proceeds to step S160.

Since the processes of steps S160 to S162 are the same as the processes of steps S104 to S106 of FIG. 9, description will be omitted. After the process of step S162, the process returns to step S127 of FIG. 11 and proceeds to step S128.

On the other hand, in a case where it is determined in step S157 that there is no request, the process returns to step S127 of FIG. 11 and proceeds to step S128. Further, in a case where it is determined in step S159 that the sub audio signal is not transmitted from the home server 14 according to a request, for example, in a case where a sub audio signal is not stored in the home server 14 or in a case where there is an error in the communication with the home server 14, the process returns to step S127 of FIG. 11 and proceeds to step S128.

FIG. 13 is a flowchart describing the details of the synthesis process of step S136 of FIG. 11.

An audio synthesis unit 83 determines whether or not the sampling frequency of the sub audio signal is to be converted in step S180 of FIG. 13. For example, in a case where the sampling frequencies of the sub audio signal and the main audio signal are not the same, it is determined in step S180 that the sampling frequency of the sub audio signal is to be converted, and the process proceeds to step S181.

In step S181, the audio synthesis unit 93 converts the sampling frequency of the sub audio signal so that the sampling frequency of the sub audio signal is the same as the sampling frequency of the main audio signal, and advances the process to step S182.

On the other hand, in a case where the sampling frequencies of the sub audio signal and the main audio signal are the same, it is determined in step S180 that the sampling frequency of the sub audio signal is not to be converted, and the process proceeds to step S182.

The audio synthesis unit 93 determines whether or not the sub audio signal is an audio signal of a musical composition, that is, whether or not the karaoke function is ineffective, in step S182. In a case where it is determined in step S182 that the sub audio signal is an audio signal of a musical composition, the process proceeds to step S183.

The audio synthesis unit 93 makes the phase of the sub audio signal for which the sampling frequency has been converted into an antiphase of the main audio signal in step S183, and advances the process to step S184.

On the other hand, in a case where it is determined in step S182 that the sub audio signal is not an audio signal of a musical composition, that is, in a case where the sub audio signal is a karaoke audio signal, the process proceeds to step S184.

In step S184, similarly to the audio synthesis unit 40 of FIG. 2, the audio synthesis unit 93 synthesizes the main audio signal with the sub audio signal at a predetermined ratio, and generates a synthesized audio signal.

Here, in a case where the sub audio signal is a karaoke musical composition audio signal, C1 in a case where a control signal to output only the main audio signal is not supplied from the audio synchronization processing unit 51 is 0, and C2 is 1. On the other hand, in a case where the sub audio signal is an audio signal of a musical composition, C1 and C2 in a case where a control signal to output only the main audio signal is not supplied from the audio synchronization processing unit 51 are 0.5. Further, C1 in a case where a control signal to output only the main audio signal is supplied from the audio synchronization processing unit 51 is 1, and C2 is 0. After the process of step S184, the process returns to step S136 of FIG. 11 and proceeds to step S137.

As described above, the television set 11 of FIG. 10 extracts the feature amounts of the main audio signal and the sub audio signal, generates the synchronization information based on the feature amounts, and synthesizes the main audio signal with the sub audio signal based on the synchronization information. In so doing, since the sub audio signal is able to be output by being synchronized with the main audio signal, for example, the audio of a musical composition of a program is able to be changed naturally to the audio of a karaoke musical composition. Further, for example, the BGM of a program is able to be made smaller by an antiphase audio of the BGM.

Here, while the television set 11 of FIG. 10 receives the sub audio signal from the home server 14, the same is also true in a case where the sub audio signal is received from the broadcast station server 13 or the cloud service device 12 except that the connection destination is the broadcast station server 13 or the cloud service device 12.

### Second Embodiment

### Configuration Example of Second Embodiment of Signal Processing System

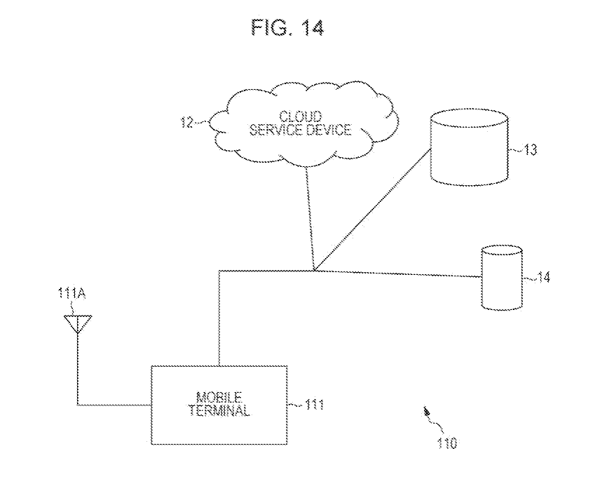

FIG. 14 is a view illustrating a configuration example of a second embodiment of a signal processing system according to an embodiment of the present technology.

Of the configurations illustrated in FIG. 14, the same symbols are given to configurations that are the same as the configurations of FIG. 1. Overlapping description will be omitted as appropriate.

The configuration of a signal processing system 110 of FIG. 14 differs from the configuration of FIG. 1 mainly in that a mobile terminal 111 is provided instead of the television set 11. In the signal processing system 110, the mobile terminal 111 receives a 1seg broadcast performed using only one segment out of thirteen segments of a terrestrial digital broadcast, and the main audio signal and the sub audio signal of the 1seg broadcast are synthesized.

Specifically, the mobile terminal 111 receives a 1seg broadcast wave transmitted from a broadcast station via an antenna 111A, for example, and obtains a broadcast signal transmitted on the broadcast wave. The mobile terminal 111 decodes the encoded program information out of the broadcast signal, and requests the cloud service device 12, the broadcast station server 13, or the home server 14 for the sub audio signal via a network based on the program information obtained as a result. The mobile terminal 111 receives the sub audio signal transmitted via the network according to the request.

The mobile terminal 111 decodes the encoded picture signal and the encoded main audio signal of the 1seg broadcast. The mobile terminal 111 generates a synthesized audio signal by synthesizing the main audio signal and the sub audio signal obtained as a result of the decoding. The mobile terminal 111 outputs the synthesized audio signal along with the picture signal obtained as a result of the decoding.

Since the specific processing of the mobile terminal 111 is the same as the television set 11 except that a 1seg broadcast wave is received instead of a terrestrial digital broadcast, description will be omitted. However, since the mobile terminal 111 moves, circumstances in which the reception of radio waves is difficult such as within a tunnel are assumed. Therefore, for example, the accumulation capacity of the TS accumulation unit 73 of FIG. 3 is increased compared to the television set 11, and the obtaining of TS by the TS obtaining unit 74 is performed once there is more TS in the TS accumulation unit 73 compared to the television set 11.

### Third Embodiment

### Configuration Example of Third Embodiment of Signal Processing System

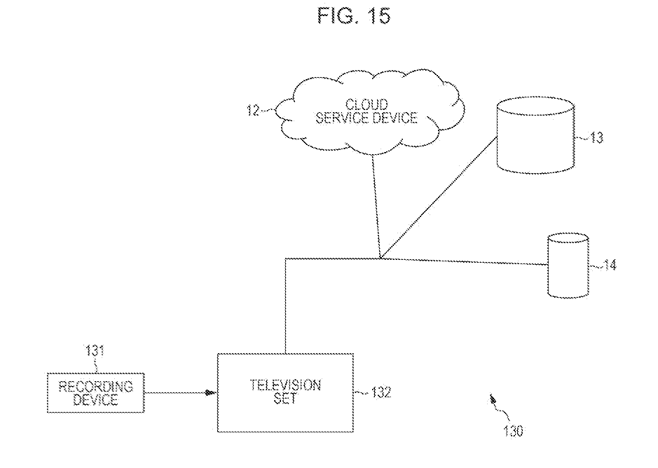

FIG. 15 is a view illustrating a configuration example of a third embodiment of a signal processing system according to an embodiment of the present technology.

Of the configurations illustrated in FIG. 15, the same symbols are given to configurations that are the same as the configurations of FIG. 1. Overlapping description will be omitted as appropriate.

The configuration of a signal processing system 130 of FIG. 15 differs from the configuration of FIG. 1 mainly in that a recording device 131 is newly provided and a television set 132 is provided instead of the television set 11. In the signal processing system 130, the television set 132 receives a broadcast signal of a television broadcast recorded on the recording device 131, and the main audio signal and the sub audio signal of the broadcast signal are synthesized.

Specifically, the recording device 131 is formed of an HDD (Hard Disk Drive) recorder or the like, for example. The recording device 131 receives the broadcast wave of a terrestrial digital broadcast transmitted from a broadcast station via an antenna (not shown), and obtains and records the TS of the broadcast signal transmitted on the broadcast wave.

The television set 132 reads the TS of the broadcast signal from the recording device 131. Similarly to the television set 11 of FIG. 1, the television set 132 decodes the encoded program information out of the broadcast signal, and requests the cloud service device 12, the broadcast station server 13, or the home server 14 for the sub audio signal via a network based on the program information obtained as a result. Similarly to the television set 11, the television set 132 receives the sub audio signal transmitted via the network according to the request.

Similarly to the television set 11, the television set 132 decodes the encoded picture signal and the encoded main audio signal out of the broadcast signal. Similarly to the television set 11, the television set 132 generates a synthesized audio signal by synthesizing the main audio signal and the sub audio signal obtained as a result of the decoding. The television set 132 outputs the synthesized audio signal along with the picture signal obtained as a result of the decoding.

### Configuration Example of Television Set

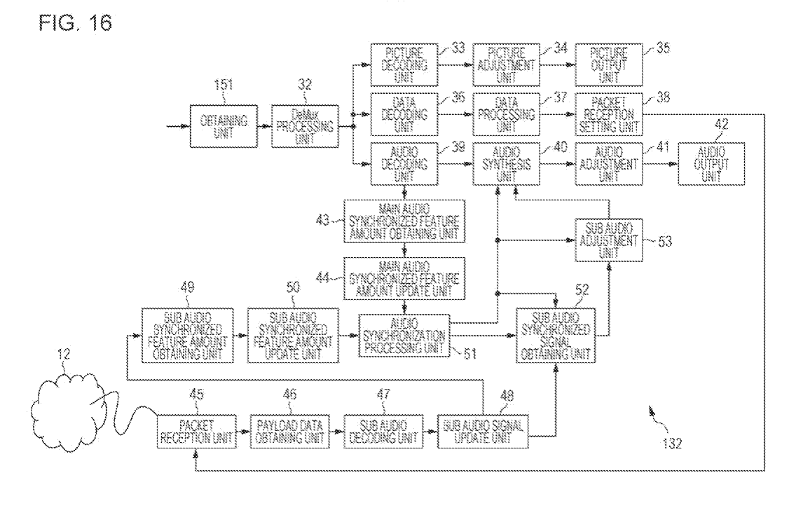

FIG. 16 is a block diagram illustrating a configuration example of the television set 132 of FIG. 15.

Of the configurations illustrated in FIG. 16, the same symbols are given to configurations that are the same as the configurations of FIG. 2. Overlapping description will be omitted as appropriate.

The configuration of the television set 132 of FIG. 16 differs from the configuration of FIG. 2 mainly in that an obtaining unit 151 is provided instead of the broadcast reception unit 31.

The obtaining unit 151 obtains the TS of a broadcast signal designated by the user from the recording device 131 in predetermined processing units, and supplies the TS to the DeMux processing unit 32.

### Description of Process of Television Set

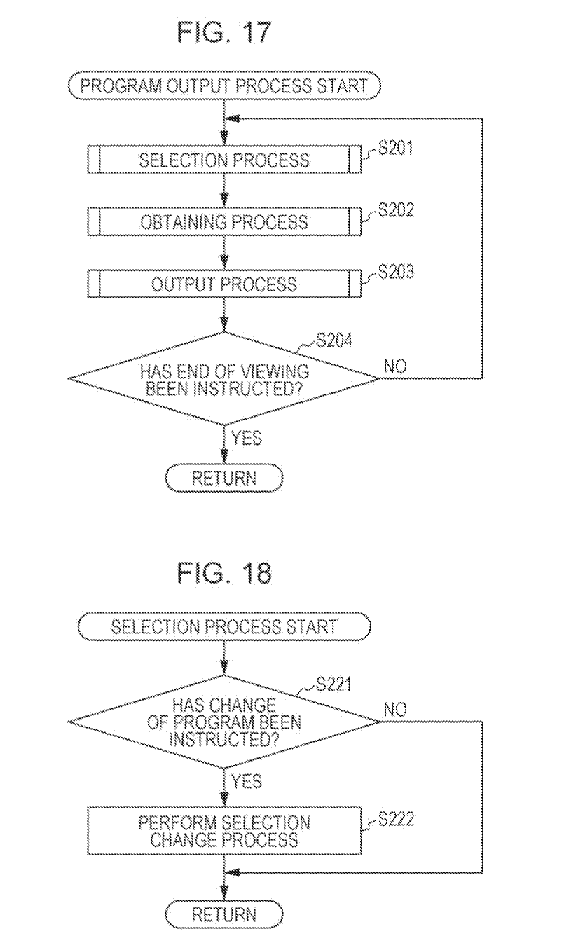

FIG. 17 is a flowchart describing a program output process of the television set 132 of FIG. 16. The program output process is started, for example, when the user instructs the start of viewing to the television set 132 by operating an input unit (not shown).

The obtaining unit 151 of the television set 132 performs a selection process of selecting the reproduction target broadcast signal in step S201 of FIG. 17. The details of the selection process will be described with reference to FIG. 18 described later.

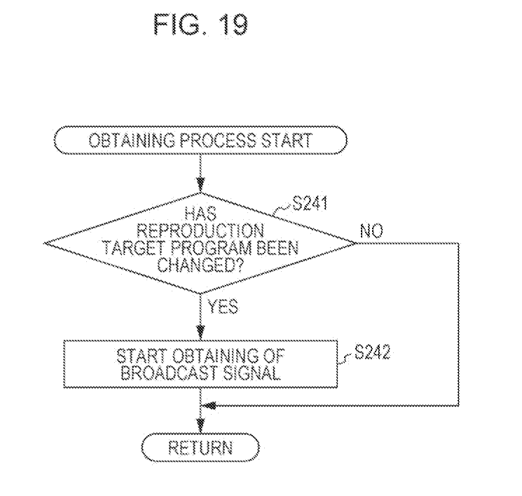

The obtaining unit 151 performs an obtaining process of obtaining the reproduction target broadcast signal from the recording device 131 in step S202. The details of the obtaining process will be described with reference to FIG. 19 described later.

Since the processes of steps S203 and S204 are respectively the same as the processes of steps S13 and S14 of FIG. 5, description will be omitted.

FIG. 18 is a flowchart describing the details of the selection process of step S201 of FIG. 17.

In step S221 of FIG. 18, the obtaining unit 151 determines whether or not the user has instructed a change in the program to be reproduced by operating an input unit (not shown). Here, during the process of the first step S221, it is determined that the user has instructed a change in the program to be reproduced.

In a case where it is determined in step S221 that the user has instructed a change in the program to be reproduced, the obtaining unit 151 performs a selection change process in step S222 of making a program change flag which is being retained indicating that the reproduction target program has been changed effective and turning off an obtaining ready flag indicating that obtaining preparations have been made. Furthermore, the process returns to step S201 of FIG. 17 and proceeds to step S202.

On the other hand, in a case where it is determined in step S221 that the user has not instructed a change in the program to be reproduced, the process returns to step S201 of FIG. 17 and proceeds to step S202.

FIG. 19 is a flowchart describing the details of the obtaining process of step S202 of FIG. 17.

The obtaining unit 151 determines whether or not the reproduction target program has been changed based on the program change flag in step S241 of FIG. 19. In a case where it is determined in step S241 that the reproduction target program has been changed, the process proceeds to step S242.

In step S242, the obtaining unit 151 stops the obtaining of a broadcast signal from the recording device 131 and starts the obtaining of a broadcast signal of a program designated by the user. Furthermore, the obtaining unit 151 makes the program change flag ineffective and turns on the obtaining ready flag. Furthermore, the process returns to step S202 of FIG. 17 and proceeds to step S203.

On the other hand, in a case where it is determined in step S241 that the reproduction target program has not been changed, the process returns to step S202 of FIG. 17 and proceeds to step S203.

As described above, the television set 132 of FIG. 15 extracts the feature amounts of the main audio signal and the sub audio signal, generates the synchronization information based on the feature amounts, and synthesizes the main audio signal with the sub audio signal based on the synchronization information. In so doing, the sub audio signal is able to be output by being synchronized with the main audio signal. As a result, even in a case where the recording device 131 has recorded with the sound quality of the main audio signal lowered, by outputting a sub audio signal formed of a high sound quality main audio signal instead of the main audio signal, high sound quality audio is able to be output naturally. Accordingly, the recording device 131 is able to reduce the data amount by recording with the sound quality of the main audio signal lowered.

Here, while the recording device 131 records the broadcast signal in the TS format in the third embodiment, the broadcast signal may be recorded in a different format.

Further, while the television set 132 of FIG. 15 receives the sub audio signal from the cloud service device 12, the same is also true in a case where the sub audio signal is received from the broadcast station server 13 or the home server 14 except that the connection destination is the broadcast station server 13 or the home server 14.

### Fourth Embodiment

### Configuration Example of Fourth Embodiment of Signal Processing System

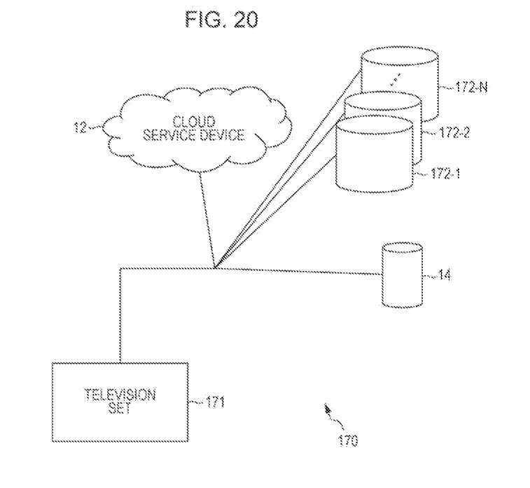

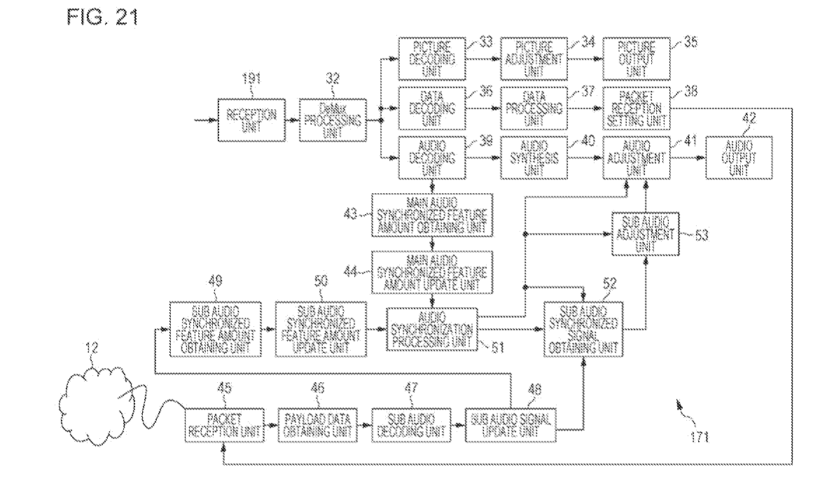

FIG. 20 is a view illustrating a configuration example of a fourth embodiment of a signal processing system according to an embodiment of the present technology.

Of the configurations illustrated in FIG. 20, the same symbols are given to configurations that are the same as the configurations of FIG. 1. Overlapping description will be omitted as appropriate.

The configuration of a signal processing system 170 of FIG. 20 differs from the configuration of FIG. 1 mainly in that a television set 171 and broadcast station servers 172-1 to 172-N are provided instead of the television set 11 and the broadcast station server 13. In the signal processing system 170, the television set 171 receives the TS of a broadcast signal of a terrestrial digital broadcast via a network from the broadcast station servers 172-1 to 172-N, and the main audio signal and the sub audio signal out of the broadcast signal are synthesized.

Specifically, the television set 171 obtains the TS of the broadcast signal via the network from the broadcast station servers 172-1 to 172-N. Similarly to the television set 11 of FIG. 1, the television set 171 decodes the encoded program information out of the broadcast signal, and based on the program information obtained as a result, requests the cloud service device 12, the broadcast station servers 172-1 to 172-N, or the home server 14 for the sub audio signal via the network. Similarly to the television set 11, the television set 171 receives the sub audio signal transmitted via the network according to the request.

Similarly to the television set 11, the television set 171 decodes the encoded picture signal and the encoded main audio signal out of the broadcast signal. Similarly to the television set 11, the television set 171 generates a synthesized audio signal by synthesizing the main audio signal and the sub audio signal obtained as a result of the decoding. The television set 171 outputs the synthesized audio signal along with the picture signal obtained as a result of the decoding.

The broadcast station servers 172-1 to 172-N are respectively servers managed by broadcast stations of terrestrial digital broadcasts, and store a broadcast signal and a sub audio signal. Here, in a case where there is no particular reason for distinguishing the broadcast station servers 172-1 to 172-N below, the broadcast station servers are collectively referred to as a broadcast station server 172.

The broadcast station server 172 transmits a broadcast signal via a network. Further, the broadcast station server 172 transmits the stored sub audio signal to the television set 171 according to a request by the television set 171.

### Configuration Example of Television Set

FIG. 21 is a block diagram illustrating a configuration example of the television set 171 of FIG. 20.

Of the configurations illustrated in FIG. 21, the same symbols are given to configurations that are the same as the configurations of FIG. 2. Overlapping description will be omitted as appropriate.

The configuration of the television set 171 of FIG. 21 differs from the configuration of FIG. 2 mainly in that a reception unit 191 is provided instead of the broadcast reception unit 31.

The reception unit 191 receives TS packets of the broadcast signal of a terrestrial digital broadcast via a network from the broadcast station server 172, and obtains the TS of the broadcast signal from the TS packets. The reception unit 191 accumulates the TS of the broadcast signal. The reception unit 191 supplies the accumulated TS of the broadcast signal to the DeMux processing unit 32.

### Description of Process of Television Set

Since a program output process of the television set 171 of FIG. 20 is the same as the program output process of FIG. 5 except for the broadcast reception process of step S12 of FIG. 5, only the broadcast reception process will be described.

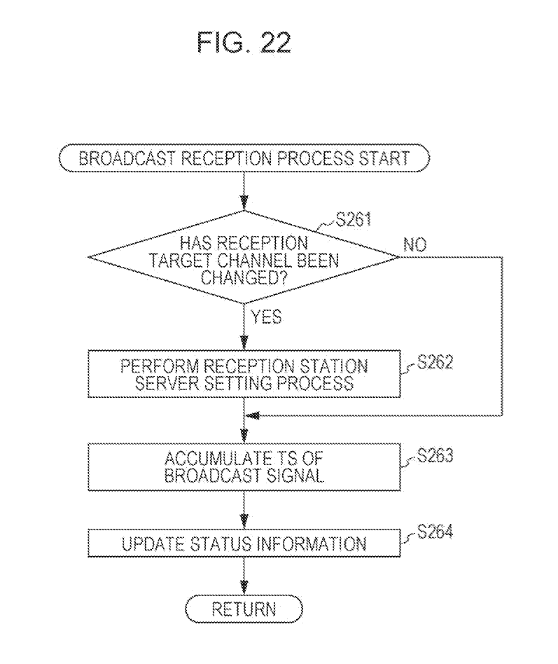

FIG. 22 is a flowchart describing the broadcast reception process by the reception unit 191 of FIG. 21.

The reception unit 191 determines whether or not the reception target channel has been changed based on a change flag in step S261 of FIG. 22. In a case where it is determined in step S261 that the reception target channel has been changed, the process proceeds to step S262.

In step S262, the reception unit 191 performs a process of setting the broadcast station server 172 of the broadcast signal being received to a broadcast station server 172 of a channel instructed by the user, an initialization process, or the like as a reception station server setting process. Furthermore, the reception unit 191 makes the change flag ineffective, turns on a ready flag, and advances the process to step S263.

On the other hand, in a case where it is determined in step S261 that the reception target channel has not been changed, the process proceeds to step S263.

In step S263, the reception unit 191 receives TS packets of the broadcast signal via a network from the broadcast station server 172 set as the broadcast station server 172 of the broadcast signal received in step S262, and accumulates the TS included in the TS packets.

The reception unit 191 updates the status information of the retained accumulated TS (for example, the amount of TS yet to be read, or the like) in step S264. Furthermore, the broadcast reception process is ended.

Here, while the television set 171 of FIG. 21 receives the sub audio signal from the cloud service device 12, the same is also true in a case where the broadcast station server 172 or the home server 14 receives the sub audio signal except that the connection destination is the broadcast station server 172 or the home server 14.

Further, while description is omitted, even in a case where the sub audio signal is an audio signal in a language different to the main audio signal or includes an audio signal in a language different to the main audio signal, the same process is performed as the case described above where the sub audio signal is an audio signal with less sound quality deterioration than the main audio signal. At this time, in a case where the sub audio signal is an audio signal including an audio signal in a language different to the main audio signal and an audio signal of the BGM as the audio signal of each channel, the same adjustment process as in a case where the sub audio signal includes an audio signal of the main audio of a television drama, a movie, or the like (for example, lines or the like) and an audio signal of the BGM as the audio signals of different channels is performed on the sub audio signal.

Further, the synthesis method of the main audio signal with the sub audio signal may be a method other than the method described above. For example, only sub audio signals of a predetermined segment may be synthesized with the main audio signal. Further, of all channels of sub audio signals, sub audio signals of channels other than channels of audio signals able to be synchronized with the main audio signal may be synthesized with the main audio signal. In so doing, for example, in a case where the sub audio signal is an audio signal including audio signals of a plurality of languages corresponding to the main audio signal as audio signals of different channels for each language, the audio of a predetermined language corresponding to the main audio signal and the audio in a language corresponding to a sub audio signal of another language may be output at the same time.

Furthermore, the main audio signal and the sub audio signal are not limited to the signals described above.

Further, the specification information is not necessarily included in the broadcast signal, and may be downloaded by the user via a network or stored on the home server 14 by the user.

### Fifth Embodiment

Description of Computer on which Embodiment of Present Technology is Applied

The series of processes described above may be executed by hardware or may be executed by software. In a case where the series of processes is executed by software, a program configuring the software is installed on a computer. Here, examples of the computer include a computer in which dedicated hardware is built in, a general-purpose personal computer, for example, able to execute various functions by installing various programs, and the like.

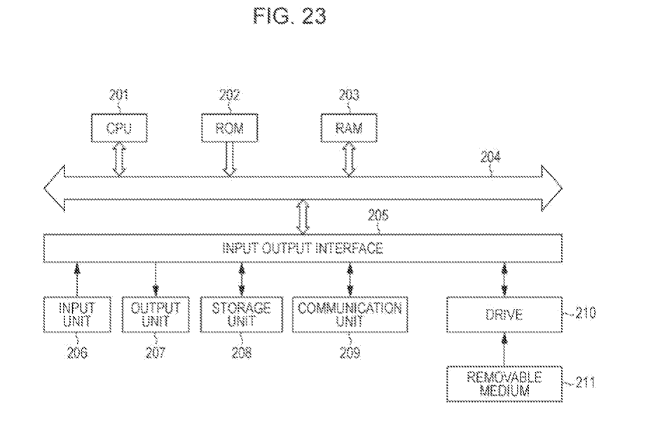

FIG. 23 is a block diagram illustrating a configuration example of hardware of a computer executing the series of processes described above using a program.

In the computer, a CPU (Central Processing Unit) 201, a ROM (Read Only Memory) 202, and a RAM (Random Access Memory) 203 are connected to one another by a bus 204.

An input output interface 205 is further connected to the bus 204. An input unit 206, an output unit 207, a storage unit 208, a communication unit 209, and a drive 210 are connected to the input output interface 205.

The input unit 206 is formed of a keyboard, a mouse, a microphone, and the like. The output unit 207 is formed of a display, a speaker, or the like. The storage unit 208 is formed of a hard disk, a non-volatile memory, or the like. The communication unit 209 is formed of a network interface or the like. The drive 210 drives a removable medium 211 such as a magnetic disk, an optical disc, a magneto-optical disc, a semiconductor memory, or the like.

In the computer configured as described above, the series of processes described above is performed by the CPU 201 executing a program stored in the storage unit 208, for example, by loading the program on the RAM 203 via the input output interface 205 and the bus 204.

The program that the computer (CPU 201) executes is able to be provided, for example, by being recorded on the removable medium 211 as a packaged medium or the like. Further, the program is able to be provided via a wired or wireless transmission medium such as a local area network, the Internet, or a digital satellite broadcast.

In the computer, the program is able to be installed on the storage unit 208 via the input output interface 205 by fitting the removable medium 211 to the drive 210. Further, the program is able to be installed on the storage unit 208 by being received by the communication unit 209 via a wired or wireless transmission medium. Otherwise, the program may also be installed on the ROM 202 or the storage unit 208 in advance.

Here, the program that the computer executes may be a program in which processing is performed in time series along the order described in the present specification, or may be a program in which processing is performed at necessary timings such as in parallel or when a call is made.

Here, in the present specification, a system denotes a collection of a plurality of constituent elements (devices, modules (parts), and the like), and not all constituent elements are necessarily within the same housing. Therefore, a plurality of devices stored in separate housings connected via a network and one device in which a plurality of modules are stored within one housing are both systems.

Further, the embodiments of the present technology are not limited to the embodiments described above, and various modifications are possible without departing from the gist of the present technology.

For example, the embodiments of the present technology may adopt a configuration of cloud computing in which one function is divided and processed in cooperation by a plurality of devices via a network.

Further, each step described in the flowcharts described above may be executed by one device or may be executed divided between a plurality of devices.

Furthermore, in a case where a plurality of processes are included in one step, the plurality of processes included in the one step may be executed by one device or may be executed divided between a plurality of devices.

Here, the embodiments of the present technology may also adopt the following configurations.

(1)

A signal processing device including: a feature amount calculation unit calculating the respective feature amount of a first audio signal obtained through a first communication pathway and a second audio signal obtained through a second communication pathway corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

(2)

The signal processing device according to (1), further including: a display control unit controlling the display of a picture signal, obtained through the first communication pathway, corresponding to the first audio signal.

(3)

The signal processing device according to (1) or (2), wherein the first communication pathway is a broadcast wave, and the second communication pathway is determined based on attached information received through the broadcast wave.

(4)

The signal processing device according to (1) or (2), wherein the first communication pathway and the second communication pathway are the same.

(5)

The signal processing device according to any one of (1) to (4), wherein the second audio signal is an audio signal in which there is little sound quality deterioration from the first audio signal, and the audio synthesis unit synthesizes the first audio signal with the second audio signal with a ratio of 0 to 1 based on the synchronization information.

(6)

The signal processing device according to any one of (1) to (4), wherein the second audio signal is an audio signal with a different language to the first audio signal, and the audio synthesis unit synthesizes the first audio signal with the second audio signal with a ratio of 0 to 1 based on the synchronization information.

(7)

The signal processing device according to any one of (1) to (4), wherein the second audio signal is an audio signal of a karaoke musical composition of a musical composition corresponding to the first audio signal, and the audio synthesis unit synthesizes the first audio signal with the second audio signal with a ratio of 0 to 1 based on the synchronization information.

(8)

The signal processing device according to any one of (1) to (4), wherein the first audio signal is an audio signal including the audio signal of a BGM (Background Music) and the audio signal of a main audio as audio signals of different channels, the second audio signal is the audio signal of the BGM, and the audio synthesis unit synthesizes the second audio signal as an antiphase of the audio signal of the channel of the BGM with the first audio signal.

(9)

A signal processing method of a signal processing device including: calculating the respective feature amount of a first audio signal obtained through a first communication pathway and a second audio signal obtained through a second communication pathway corresponding to the first audio signal; audio synchronization processing generating synchronization information of the first audio signal and the second audio signal based on the feature amounts calculated in the calculating of the feature amount; and audio synthesizing the first audio signal with the second audio signal based on the synchronization information generated by the audio synchronization processing.

(10)

A program causing a computer to function as a signal processing device including: a feature amount calculation unit calculating the respective feature amount of a first audio signal obtained through a first communication pathway and a second audio signal obtained through a second communication pathway corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

(11)

A recording medium on which the program according to (10) is recorded.

(12)

A signal processing system including: a first signal processing device including a first transmission unit transmitting a first audio signal through a first communication pathway; a second signal processing device including a second transmission unit transmitting a second audio signal corresponding to the first audio signal through a second transmission pathway; and a third signal processing device including a first reception unit receiving the first audio signal transmitted from the first transmission unit, a second reception unit receiving the second audio signal transmitted from the second transmission unit, a feature amount calculation unit calculating the respective feature amount of the first audio signal received by the first reception unit and the second audio signal received by the second reception unit, an audio synchronization processing unit generating synchronization information of the first audio signal and the second audio signal based on the feature amounts calculated by the feature amount calculation unit, and an audio synthesis unit synthesizing the first audio signal with the second audio signal based on the synchronization information generated by the audio synchronization processing unit.

(13)

A signal processing method of a signal processing system including first to third signal processing devices, the method including: transmitting a first audio signal through a first communication pathway by the first signal processing device; receiving the first audio signal from the first signal processing device by the third signal processing device; transmitting a second audio signal corresponding to the first audio signal through the second transmission pathway by the second signal processing device; receiving the second audio signal from the second signal processing device by the third signal processing device; calculating the respective feature amount of the received first audio signal and the second audio signal by the third signal processing device; generating synchronization information of the first audio signal and the second audio signal based on the calculated feature amounts by the third signal processing device; and synthesizing the first audio signal with the second audio signal based on the generated synchronization information by the third signal processing device.

(14)

A signal processing device including: a feature amount calculation unit calculating the respective feature amount of a first audio signal obtained through a predetermined communication pathway and a second audio signal read from a storage unit corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

(15)

The signal processing device according to (14), further including: a reading control unit performing a control to read the second audio signal from the storage unit based on information specifying the first audio signal.

(16)

A signal processing method of a signal processing device including: calculating the respective feature amount of a first audio signal obtained through a predetermined communication pathway and a second audio signal read from a storage unit corresponding to the first audio signal; audio synchronization processing generating synchronization information of the first audio signal and the second audio signal based on the feature amounts calculated in the calculating of the feature amount; and audio synthesizing the first audio signal with the second audio signal based on the synchronization information generated by the audio synchronization processing.

(17)

A program causing a computer to function as a signal processing device including: a feature amount calculation unit calculating the respective feature amount of a first audio signal obtained through a predetermined communication pathway and a second audio signal read from a storage unit corresponding to the first audio signal; an audio synchronization processing unit generating synchronization information of the first audio signal and the second audio signal based on the feature amounts calculated by the feature amount calculation unit; and an audio synthesis unit synthesizing the first audio signal with the second audio signal based on the synchronization information generated by the audio synchronization processing unit.

(18)

A recording medium on which the program according to (17) is recorded.

(19)

A signal processing system including: a first signal processing device including a transmission unit transmitting a first audio signal through a predetermined communication pathway; a second signal processing device including a storage unit storing a second audio signal corresponding to the first audio signal; and a third signal processing device including a reception unit receiving the first audio signal transmitted from the transmission unit, an obtaining unit obtaining the second audio signal read from the storage unit, a feature amount calculation unit calculating the respective feature amount of the first audio signal received by the reception unit and the second audio signal obtained by the obtaining unit, an audio synchronization processing unit generating synchronization information of the first audio signal and the second audio signal based on the feature amounts calculated by the feature amount calculation unit, and an audio synthesis unit synthesizing the first audio signal with the second audio signal based on the synchronization information generated by the audio synchronization processing unit.

(20)

A signal processing method of a signal processing system including first to third signal processing devices, the method including: transmitting a first audio signal through a predetermined communication pathway by the first signal processing device; receiving the first audio signal from the first signal processing device by the third signal processing device; reading the second audio signal from the storage unit storing the second audio signal corresponding to the first audio signal by the second processing device; obtaining the second audio signal read from the second signal processing device by the third signal processing device; calculating the respective feature amount of the received first audio signal and the read second audio signal by the third signal processing device; generating synchronization information of the first audio signal and the second audio signal based on the calculated feature amounts by the third signal processing device; and synthesizing the first audio signal with the second audio signal based on the generated synchronization information by the third signal processing device.

The present technology contains subject matter related to that disclosed in Japanese Priority Patent Application JP 2011-283816 filed in the Japan Patent Office on Dec. 26, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a feature amount calculation unit calculating a respective feature amount of a first audio signal obtained through a first communication pathway and a second audio signal obtained through a second communication pathway corresponding to the first audio signal;
an audio synchronization processing unit generating synchronization information of the first audio signal and the second audio signal based on the feature amounts calculated by the feature amount calculation unit; and
an audio synthesis unit synthesizing the first audio signal with the second audio signal based on the synchronization information generated by the audio synchronization processing unit.

2. The signal processing device according to claim 1, further comprising:
a display control unit controlling a display of a picture signal, obtained through the first communication pathway, corresponding to the first audio signal.

3. The signal processing device according to claim 1,
wherein the first communication pathway is a broadcast wave, and
the second communication pathway is determined based on attached information received through the broadcast wave.

4. The signal processing device according to claim 1,
wherein the first communication pathway and the second communication pathway are the same.

5. The signal processing device according to claim 1,
wherein the second audio signal is an audio signal in which there is little sound quality deterioration from the first audio signal, and
the audio synthesis unit synthesizes the first audio signal with the second audio signal with a ratio of 0 to 1 based on the synchronization information.

6. The signal processing device according to claim 1,
wherein the second audio signal is an audio signal with a different language to the first audio signal, and
the audio synthesis unit synthesizes the first audio signal with the second audio signal with a ratio of 0 to 1 based on the synchronization information.

7. The signal processing device according to claim 1,
wherein the second audio signal is an audio signal of a karaoke musical composition of a musical composition corresponding to the first audio signal, and
the audio synthesis unit synthesizes the first audio signal with the second audio signal with a ratio of 0 to 1 based on the synchronization information.

8. The signal processing device according to claim 1,
wherein the first audio signal is an audio signal including the audio signal of a BGM (Background Music) and the audio signal of a main audio as audio signals of different channels,
the second audio signal is the audio signal of the BGM, and
the audio synthesis unit synthesizes the second audio signal as an antiphase of the audio signal of a channel of the BGM with the first audio signal.

9. A signal processing method of a signal processing device comprising:
calculating a respective feature amount of a first audio signal obtained through a first communication pathway and a second audio signal obtained through a second communication pathway corresponding to the first audio signal;
audio synchronization processing generating synchronization information of the first audio signal and the second audio signal based on the feature amounts calculated in the calculating of the feature amount; and
audio synthesizing the first audio signal with the second audio signal based on the synchronization information generated by the audio synchronization processing.

10. A program causing a computer to function as a signal processing device comprising:
a feature amount calculation unit calculating a respective feature amount of a first audio signal obtained through a first communication pathway and a second audio signal obtained through a second communication pathway corresponding to the first audio signal;
an audio synchronization processing unit generating synchronization information of the first audio signal and the second audio signal based on the feature amounts calculated by the feature amount calculation unit; and
an audio synthesis unit synthesizing the first audio signal with the second audio signal based on the synchronization information generated by the audio synchronization processing unit.

11. A recording medium on which the program according to claim 10 is recorded.

12. A signal processing system comprising:
a first signal processing device including a first transmission unit transmitting a first audio signal through a first communication pathway;
a second signal processing device including a second transmission unit transmitting a second audio signal corresponding to the first audio signal through a second transmission pathway; and
a third signal process device including
a first reception unit receiving the first audio signal transmitted from the first transmission unit,
a second reception unit receiving the second audio signal transmitted from the second transmission unit,
a feature amount calculation unit calculating a respective feature amount of the first audio signal received by the first reception unit and the second audio signal received by the second reception unit,
an audio synchronization processing unit generating synchronization information of the first audio signal and the second audio signal based on the feature amounts calculated by the feature amount calculation unit, and
an audio synthesis unit synthesizing the first audio signal with the second audio signal based on the synchronization information generated by the audio synchronization processing unit.

13. A signal processing method of a signal processing system including first to third signal processing devices, the method comprising:
transmitting a first audio signal through a first communication pathway by the first signal processing device;
receiving the first audio signal from the first signal processing device by the third signal processing device;
transmitting a second audio signal corresponding to the first audio signal through the second transmission pathway by the second signal processing device;
receiving the second audio signal from the second signal processing device by the third signal processing device;
calculating a respective feature amount of the received first audio signal and the second audio signal by the third signal processing device;
generating synchronization information of the first audio signal and the second audio signal based on the calculated feature amounts by the third signal processing device; and
synthesizing the first audio signal with the second audio signal based on the generated synchronization information by the third signal processing device.

14. A signal processing device comprising:
a feature amount calculation unit calculating a respective feature amount of a first audio signal obtained through a predetermined communication pathway and a second audio signal read from a storage unit corresponding to the first audio signal;
an audio synchronization processing unit generating synchronization information of the first audio signal and the second audio signal based on the feature amounts calculated by the feature amount calculation unit; and
an audio synthesis unit synthesizing the first audio signal with the second audio signal based on the synchronization information generated by the audio synchronization processing unit.

15. The signal processing device according to claim 14, further comprising:
a reading control unit performing a control to read the second audio signal from the storage unit based on information specifying the first audio signal.

16. A signal processing method of a signal processing device comprising:
calculating a respective feature amount of a first audio signal obtained through a predetermined communication pathway and a second audio signal read from a storage unit corresponding to the first audio signal;
audio synchronization processing generating synchronization information of the first audio signal and the second audio signal based on the feature amounts calculated in the calculating of the feature amount; and
audio synthesizing the first audio signal with the second audio signal based on the synchronization information generated by the audio synchronization processing.

17. A program causing a computer to function as a signal processing device comprising:
a feature amount calculation unit calculating a respective feature amount of a first audio signal obtained through a predetermined communication pathway and a second audio signal read from a storage unit corresponding to the first audio signal;
an audio synchronization processing unit generating synchronization information of the first audio signal and the second audio signal based on the feature amounts calculated by the feature amount calculation unit; and
an audio synthesis unit synthesizing the first audio signal with the second audio signal based on the synchronization information generated by the audio synchronization processing unit.

18. A recording medium on which the program according to claim 17 is recorded.

19. A signal processing system comprising:
a first signal processing device including a transmission unit transmitting a first audio signal through a predetermined communication pathway;
a second signal processing device including a storage unit storing a second audio signal corresponding to the first audio signal; and
a third signal processing device including
a reception unit receiving the first audio signal transmitted from the transmission unit,
an obtaining unit obtaining the second audio signal read from the storage unit,
a feature amount calculation unit calculating a respective feature amount of the first audio signal received by the reception unit and the second audio signal obtained by the obtaining unit,
an audio synchronization processing unit generating synchronization information of the first audio signal and the second audio signal based on the feature amounts calculated by the feature amount calculation unit, and
an audio synthesis unit synthesizing the first audio signal with the second audio signal based on the synchronization information generated by the audio synchronization processing unit.

20. A signal processing method of a signal processing system including first to third signal processing devices, the method comprising:
transmitting a first audio signal through a predetermined communication pathway by the first signal processing device;
receiving the first audio signal from the first signal processing device by the third signal processing device;
reading a second audio signal from the storage unit storing the second audio signal corresponding to the first audio signal by the second processing device;
obtaining the second audio signal read from the second signal processing device by the third signal processing device;
calculating a respective feature amount of the received first audio signal and the read second audio signal by the third signal processing device;
generating synchronization information of the first audio signal and the second audio signal based on the calculated feature amounts by the third signal processing device; and
synthesizing the first audio signal with the second audio signal based on the generated synchronization information by the third signal processing device.
